(19) United States
(12) Patent Application Publication
(10) Pub. No.: US 2026/0361655 A1
(43) Pub. Date: Nov. 12, 2026

(54) TRIGGERED CLASSIFICATION OF A TRAFFIC FLOW

(71) Applicant: QUALCOMM Incorporated, San Diego, CA (US)

(72) Inventors: John SANLI, San Francisco, CA (US); Sandip HOMCHAUDHURI, San Jose, CA (US); Prasanthi MUPPIREDDY, San Jose, CA (US); Anuradha CHANDRAMOULI, San Jose, CA (US); Nagarjun TUMKUR SHARATHKUMAR, Santa Clara, CA (US); Xiaolong HUANG, Santee, CA (US)

(21) Appl. No.: 19/203,960

(22) Filed: May 9, 2025

(51) Int. Cl. H04L 47/2441; H04L 43/16

(52) U.S. Cl. CPC H04L 47/2441; H04L 43/16

(57) ABSTRACT

This disclosure provides methods, components, devices and systems for triggered classification of a traffic flow. Some aspects more specifically relate to triggering the reclassification of traffic flows in accordance with ingress rates of traffic flows, service level agreements (SLAs) of traffic flows, or both. In some implementations, a selective classification entity may obtain information indicative of an ingress rate of a traffic flow associated with a first traffic class. Additionally, or alternatively, the selective classification entity may obtain an indication of a traffic flow associated with a first traffic class failing to satisfy an SLA of the traffic flow. The selective classification entity may output an instruction to a traffic classifier to perform a traffic classification of the traffic flow. The instruction may be in accordance with the information indicating a change of the ingress rate, the failure to satisfy the SLA associated with the traffic flow, or both.

### TECHNICAL FIELD

This disclosure relates generally to wireless communication and, more specifically, to triggered classification of a traffic flow.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus. The apparatus may include a processing system that includes processor circuitry and memory circuitry that stores code. The processing system may be configured to cause the apparatus to obtain information indicative of an ingress rate associated with a traffic flow of an application, where the traffic flow is associated with a first traffic class of a set of multiple traffic classes corresponding to the application, and output an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Another innovative aspect of the subject matter described in this disclosure can be implemented in a method for traffic classification. The method may include obtaining information indicative of an ingress rate associated with a traffic flow of an application, where the traffic flow is associated with a first traffic class of a set of multiple traffic classes corresponding to the application, and outputting an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Another innovative aspect of the subject matter described in this disclosure can be implemented in an apparatus. The apparatus may include means for obtaining information indicative of an ingress rate associated with a traffic flow of an application, where the traffic flow is associated with a first traffic class of a set of multiple traffic classes corresponding to the application, and means for outputting an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Another innovative aspect of the subject matter described in this disclosure can be implemented in a non-transitory computer-readable medium storing code for traffic classification. The code may include instructions executable by one or more processors to obtain information indicative of an ingress rate associated with a traffic flow of an application, where the traffic flow is associated with a first traffic class of a set of multiple traffic classes corresponding to the application, and output an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

In some implementations of the method, apparatuses, and non-transitory computer-readable medium described herein, the threshold duration may be associated with a direction of the change of the ingress rate, a magnitude of the change of the ingress rate, or both.

In some implementations of the method, apparatuses, and non-transitory computer-readable medium described herein, the threshold duration may be associated with the first traffic class.

Some implementations of the method, apparatuses, and non-transitory computer-readable medium described herein may further include operations, features, means, or instructions for obtaining a confidence score associated with the first traffic class associated with the traffic flow, where the instruction to perform the traffic classification may be output in accordance with both the change of the ingress rate satisfying the at least one ingress rate threshold and the confidence score satisfying a confidence score threshold.

Another innovative aspect of the subject matter described in this disclosure can be implemented in an apparatus. The apparatus may include a processing system that includes processor circuitry and memory circuitry that stores code. The processing system may be configured to cause the apparatus to obtain an indication of a failure to satisfy a service level agreement (SLA) associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues, and output an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Another innovative aspect of the subject matter described in this disclosure can be implemented in a method for traffic classification. The method may include obtaining an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues, and outputting an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Another innovative aspect of the subject matter described in this disclosure can be implemented in an apparatus. The apparatus may include means for obtaining an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues, and means for outputting an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Another innovative aspect of the subject matter described in this disclosure can be implemented in a non-transitory computer-readable medium storing code for traffic classification. The code may include instructions executable by one or more processors to obtain an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues, and output an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Some implementations of the method, apparatuses, and non-transitory computer-readable medium described herein may further include operations, features, means, or instructions for obtaining an indication that the traffic classification of the set of multiple traffic flows associated with the first traffic flow queue fails to result in a satisfaction of the SLA associated with the traffic flow and outputting a second instruction to perform a second traffic classification of a second set of multiple traffic flows associated with a second traffic flow queue, of the set of multiple traffic flow queues, in accordance with the indication that the traffic classification of the set of multiple traffic flows associated with the first traffic flow queue failed to result in the satisfaction of the SLA, where the second traffic flow queue may be associated with a prioritized traffic flow queue associated with a defined SLA.

Some implementations of the method, apparatuses, and non-transitory computer-readable medium described herein may further include operations, features, means, or instructions for outputting the instruction may be in accordance with the failure to satisfy the SLA being independent from network noise, a signal-to-noise ratio, or both.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a signaling diagram that supports triggered classification of a traffic flow.

FIG. 4 shows example ingress rate timelines that support triggered classification of a traffic flow.

FIG. 5 shows an example of a flowchart that supports triggered classification of a traffic flow.

FIGS. 6 and 7 show example traffic flow queue diagrams that support triggered classification of a traffic flow.

FIG. 8 shows an example of a flowchart that supports triggered classification of a traffic flow.

FIGS. 9A and 9B show example process flows that support triggered classification of a traffic flow.

FIG. 10 shows an example block diagram of an example machine learning (ML) model represented by an artificial neural network (ANN) that supports triggered classification of a traffic flow.

FIG. 11 shows an example block diagram of an example ML architecture that supports triggered classification of a traffic flow.

FIG. 12 shows a block diagram of an example device that supports triggered classification of a traffic flow.

FIGS. 13 and 14 show flowcharts illustrating example processes performable by or at an apparatus that supports triggered classification of a traffic flow.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, two or more communication devices may transmit or receive data packets of one or more traffic flows, each traffic flow associated with a respective priority, service level agreement (SLA) (such as a throughput-based SLA, a latency-based SLA, or a throughput- and latency-based SLA), or type. A communication device may allocate communication resources to data packets of a traffic flow in accordance with the priority, SLA, or type associated with the traffic flow. For example, the communication device may allocate relatively more communication resources to data packets of a relatively higher priority traffic flow as compared to data packets of a relatively lower priority traffic flow. To distinguish between traffic flows associated with different priorities, SLAs, or types, the communication device may classify the traffic flows using a traffic classifier. The traffic classifier may include or may be an example of an artificial intelligence or machine learning (AI/ML) model that classifies traffic flows into one or more traffic classes. Example traffic classes may include voice traffic, video traffic, game traffic, and livestream traffic, among others.

In some scenarios, a traffic flow may change traffic classes during a life cycle of the traffic flow. For example, during a use of an application, a traffic flow of the application may start or be initially classified as a first traffic class and, after an amount of time (such as due to a change in the use of the application), the traffic flow may transition (such as change) to have one or more characteristics associated with a second traffic class. Such one or more characteristics may include a data rate or a data rate pattern representative of the second traffic class. To support a reclassification of the traffic flow (to, for example, the second traffic class), some traffic classifiers may perform continuous reclassification, which may be associated with continuous feature extraction for the traffic flow. Continuous feature extraction for the traffic flow may involve a review and analysis, by a traffic classifier, of many (such as all or nearly all) statistics associated with the traffic flow, which may result in a relatively large consumption of processing, networking, and firmware resources due to the relatively large amount of data utilized by the traffic classifier. Moreover, characteristics of some traffic flows may change relatively rapidly or frequently (such as voice traffic in scenarios in which a user switches between speaking and being muted), which may result in a reclassification of such traffic flows by a traffic classifier occurring relatively often, which may in turn increase latency and decrease throughput (due to, for example, any change in data patterns or a single misclassification causing a change in one or more quality of service (QoS) parameters associated with a traffic flow). Thus, some networks may benefit from additional traffic reclassification mechanisms that maintain accurate traffic classifications while balancing (such as reducing or mitigating) resource consumption, QoS parameter changes, or traffic flow queue disruption by a traffic classifier.

Various aspects relate generally to selectively triggering a (re)classification of one or more traffic flows in accordance with a satisfaction of one or more conditions. Some aspects more specifically relate to selectively triggering a (re)classification of one or more traffic flows in accordance with monitoring ingress rates (such as ingress data rates) of the one or more traffic flows, SLA violations by the one or more traffic flows, or both. In some implementations, a selective classification entity (operating as or within a wireless device (such as an access point (AP) or a station (STA)), a customer premises equipment (CPE), a server device, an internet service provider (ISP) device, a cloud-based platform or service, or any other wired or wireless device) may monitor an ingress rate of a traffic flow over time and may output (such as transmit or send), to a traffic classifier, an instruction to (re)classify the traffic flow in accordance with the ingress rate satisfying a triggering condition. The selective classification entity may monitor the ingress rate of the traffic flow over time by obtaining (such as identifying, measuring, detecting, receiving, or otherwise determining) information indicative of the ingress rate of the traffic flow. In some implementations, the traffic flow may (initially) be associated with a first traffic class and the selective classification entity may output the instruction to the traffic classifier in accordance with a change of the ingress rate satisfying one or more ingress rate thresholds associated with the first traffic class or a second (different) traffic class for a threshold duration. The one or more ingress rate thresholds may be associated with an upper bound ingress rate, a lower bound ingress rate, an ingress rate pattern or behavior (such as a time series of ingress rate change), or any combination thereof. The threshold duration may be associated with the change of the ingress rate, the first traffic class, or both. For example, the threshold duration may be relatively shorter for ingress rate increases and relatively longer for ingress rate decreases. By way of further example, the threshold duration may be relatively shorter for game traffic and relatively longer for voice traffic. Additionally, or alternatively, game traffic may correspond to a first (relatively shorter) threshold duration for both ingress rate increases and ingress rate decreases, with voice traffic corresponding to a second (also relatively shorter) threshold duration for ingress rate increases and a third (relatively longer) threshold duration for ingress rate decreases. Such first and second threshold durations may be the same or different, with each being a shorter duration as compared to the third threshold duration. The traffic classifier may perform a traffic (re)classification of the traffic flow in accordance with obtaining the instruction (and may otherwise refrain from performing a traffic (re)classification of the traffic flow).

Additionally, or alternatively, the selective classification entity may obtain (such as identify, measure, detect, receive, or otherwise determine) an indication of a traffic flow associated with a first traffic class failing to satisfy an SLA of the traffic flow. In other words, the selective classification entity may obtain an indication of an SLA breach or violation by the traffic flow. In accordance with obtaining the indication of the failure to satisfy the SLA, the selective classification entity may determine (such as identify, measure, detect, or otherwise ascertain) a cause of the failure to satisfy the SLA. In scenarios in which the cause of the failure to satisfy the SLA is associated with internal traffic flow congestion (such as congestion of at least one traffic flow queue of a set of traffic flow queues), the selective classification entity may output, to the traffic classifier, an instruction to perform a traffic (re)classification of traffic flows within a same traffic flow queue as the traffic flow that failed to satisfy the SLA. In some implementations, the selective classification entity may additionally instruct the traffic classifier to perform a traffic (re)classification of traffic flows within one or more other (prioritized) traffic flow queues. The selective classification entity may output such an additional traffic (re)classification instruction to the traffic classifier in accordance with obtaining an indication that the previously instructed traffic (re)classification failed to result in a satisfaction of the SLA. In some aspects, the selective classification entity may selectively output such instruction(s) to the traffic classifier in accordance with the cause of the failure to satisfy the SLA being internal traffic flow congestion (as opposed to an external cause) because internal traffic flow congestion may be indicative of or otherwise correlated with a potential misclassification of a traffic flow within the same traffic flow queue as the traffic flow that failed to satisfy the SLA or within another (prioritized) traffic flow queue. The traffic classifier may perform a traffic (re)classification of traffic flows within the requested traffic flow queue(s) in accordance with obtaining the instruction (and may otherwise refrain from performing a traffic (re)classification of the traffic flows within the traffic flow queue(s)).

Particular aspects of the subject matter described in this disclosure can be implemented to realize one or more of the following potential advantages. By selectively instructing traffic (re)classification in accordance with ingress rate changes, SLA violations, or both, the described techniques can be used to reduce the amount of resources associated with running the traffic classifier for (re)classification of traffic flows. For example, the selective classification entity may use ingress rate changes or SLA violations alone, or in combination with one or more other relatively small data statistics, to decide at which select times the traffic classifier performs a traffic (re)classification (instead of the traffic classifier preforming continuous feature extraction to decide at which times to perform a traffic (re)classification). Further, due to the reduction in the amount of resources associated with running the traffic classifier, the time spent reclassifying traffic flows may be reduced, which may reduce latency. Moreover, aspects of the subject matter described in this disclosure may be applied to traffic flows that change traffic classes periodically, an initial classification of traffic flows that start or begin as unknown or unclassified traffic flows, or both, which may reduce resource consumption and latency associated with an initial classification of traffic flows (as, for example, the traffic classifier may refrain from classifying some traffic flows until a time at which classification becomes suitable).

Additionally, instructing traffic (re)classification in accordance with ingress rate changes may enable relatively more efficient (re)classification techniques, including in scenarios in which traffic characteristics of a traffic flow change relatively frequently. For example, a (re)classification of a traffic flow may be in accordance with an ingress rate of the traffic flow satisfying an ingress rate threshold for a threshold duration, with the threshold duration defined to avoid a frequent (back and forth) reclassification of the traffic flow between two or more traffic classes. By way of example, voice traffic may experience an ingress rate decrease when a user mutes their microphone and a threshold duration for the voice traffic class with the ingress rate decrease may be defined to avoid an immediate reclassification of the voice traffic flow as background (as the traffic might soon be reclassified back to voice when the user unmutes and resumes speaking). In other words, in accordance with the (re)classification techniques disclosed herein, a traffic flow that changes traffic classes relatively continuously may remain as the same traffic class (until satisfaction of the threshold change for the threshold duration) to reduce the resource consumption and latency associated with (re)classifying the traffic flow. The traffic (re)classification techniques described herein may further result in increased throughput (such as in accordance with more selective (re)classifications or reduced latency associated with (re)classifications), which may in turn support greater spectral efficiency, higher reliability, and greater user experience scores associated with wireless communications in a wireless communication network, among other benefits.

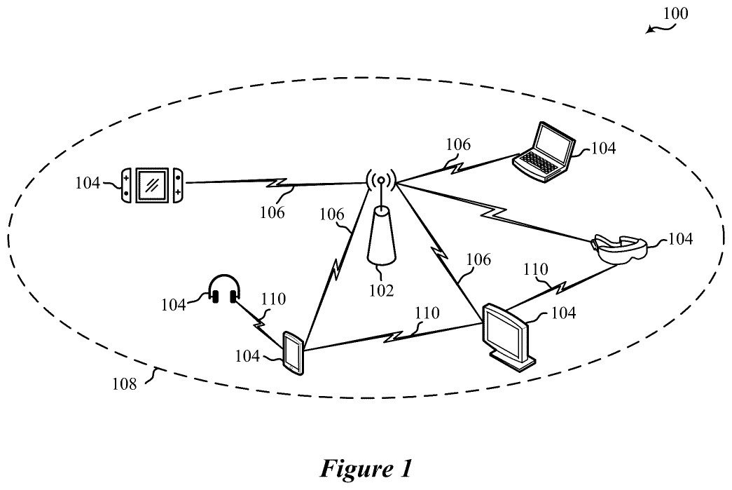

FIG. 1 shows a pictorial diagram of an example communication network 100. According to some aspects, the communication network 100 can be an example of a local area network (LAN), such as a wireless local area network (WLAN) (a Wi-Fi network). For example, the communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IM MW) study group. In some other examples, the communication network 100 can be an example of a cellular radio access network (RAN), such as a 5G or 6G RAN that implements one or more cellular protocols such as those specified in one or more 3GPP standards. In some other examples, the communication network 100 can include a WLAN that functions in an interoperable or converged manner with one or more cellular RANs to provide greater or enhanced network coverage to communication devices within the communication network 100 or to enable such devices to connect to a cellular network's core, such as to access the network management capabilities and functionality offered by the cellular network core. In some other examples, the communication network 100 can include a WLAN that functions in an interoperable or converged manner with one or more personal area networks, such as a network implementing Bluetooth or other wireless or wired technologies, to provide greater or enhanced network coverage or to provide or enable other capabilities, functionality, applications or services.

The communication network 100 may include numerous communication devices including a wireless AP 102 and any number of wireless STAs 104. While only one AP 102 is shown in FIG. 1, the communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the communication network 100. In such implementations, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IE EE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR 5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS may involve transmission on the primary 20 MHz channel. As such, in conventional systems, the transmitting device may contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in communication devices (such as APs 102 and STAs 104) to enhance various aspects associated with wireless communication. For example, an AI/ML model may be trained to identify patterns or relationships in data observed in the communication network 100. An AI/ML model may support operational decisions implemented by one or more communication devices relating to aspects described herein that are associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other communication devices (such as other STAs or APs) or provide feedback related to the communication. This may significantly expand the types of input data that can be considered as input to an AI/ML model, as such information may not otherwise be available at the other communication devices. For example, information received from other STAs or APs may include observed RSSI values, experienced packet success/failure/retry rates per client/AP, BSS/QoS load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some implementations supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some implementations, global AI/ML models may train a single classifier based on all training data received from various inputs/sources. In some implementations supporting distributed learning or distributed models, both APs and STAs may be independently capable of computing AI/ML models and sharing data with other participating communication devices in the wireless communication network such that each device can train the global AI/ML model locally. In some implementations supporting a federated learning or hybrid AI/ML model, substantially all participating communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating communication devices.

In some implementations, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some communication devices may download the AI/ML model without exchanging information with other communication devices; some communication devices may exchange information and use such information as an input to the AI/ML model without downloading it; and some communication devices may download the AI/ML model and exchange information or the AI/ML model with other communication devices).

In some implementations of the communication network 100, a (re)classification of traffic flows may be triggered in accordance with ingress rates of traffic flows, traffic flows failing to satisfy SLAs, or both. In some implementations, a selective classification entity (operating as or within a wireless device, such as an AP 102 or a STA 104 (with wireless devices potentially supporting wired communication capabilities in addition to wireless communication capabilities), a wired device, a CPE, a server device, an ISP device, or a cloud-based platform or service) may obtain information indicative of an ingress rate of a traffic flow of an application, with the traffic flow initially being associated with a first traffic class. Additionally, or alternatively, the selective classification entity may obtain an indication of a traffic flow associated with (such as classified in) a first traffic class failing to satisfy an SLA of the traffic flow, with the failure of the SLA being associated with a traffic flow congestion of at least one traffic flow queue. In accordance with (such as in response to) obtaining one or both of such indications, the selective classification entity may output an instruction to a traffic classifier (such as a traffic classifier model, which may be an ANN model or another AI/ML model) to perform a traffic (re)classification of one or more traffic flows. In some implementations, the traffic (re)classification may be in accordance with the information indicating a change of the ingress rate satisfying an ingress rate threshold associated with the first traffic class or a second traffic class and the change of the ingress rate satisfying the ingress rate threshold for a threshold duration. Additionally, or alternatively, the traffic (re)classification may be in accordance with the failure to satisfy the SLA associated with the traffic flow and the failure to satisfy the SLA associated with traffic flow being associated with the traffic flow congestion of the at least one traffic flow.

In accordance with such obtaining such an instruction to perform a traffic (re)classification, the traffic classifier may perform the traffic (re)classification of one or more traffic flows to (re)classify the one or more traffic flows into one or more traffic classes. An AP 102 or a STA 104 may transmit data packets of the one or more traffic flows in accordance with the (re)classification of the one or more traffic flows into the one or more traffic classes. For example, the AP 102 or the STA 104 may assign or allocate communication resources (such as time or frequency resources, among other examples of communication resources) to the data packets of the one or more traffic flows in accordance with the one or more traffic classes that the one or more traffic flows are (re)classified into.

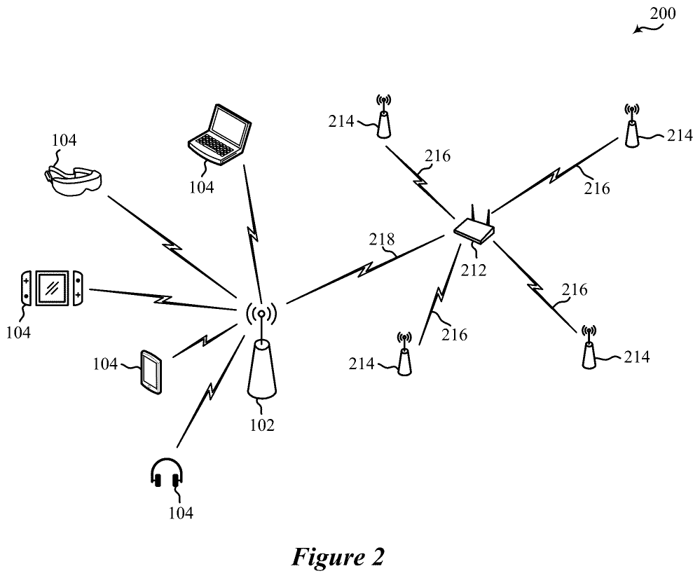

FIG. 2 shows a pictorial diagram of another example communication network 200. According to some aspects, the communication network 200 can be an example of a mesh network, an IoT network, or a sensor network in accordance with one or more of the IEEE 802.11 family of wireless communication protocol standards (including the 802.11ah amendment). Additionally, or alternatively, the communication network 200 can be an example of or include a wired network. The communication network 200 may include multiple communication devices 214, which in some implementations may include APs 102, STAs 104, or both. The communication devices 214 may represent various devices such as display devices (such as TVs, computer monitors, navigation systems, among others), music or other audio or stereo devices, remote control devices (“remotes”), printers, kitchen or other household appliances, among other examples.

In some implementations, the communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the communication devices 214. The intermediate device 212 and the communication devices 214 can communicate with one another via communication links 216, which may include wireless communication links, wired communication links, or both. In some implementations, the communication links 216 include Wi-Fi links, Bluetooth links, or other PAN or short-range communication links.

In some implementations, the intermediate device 212 also may be configured for wireless or wired communication with other networks such as with a WLAN or a wide area network (WAN) (such as a wireless (such as cellular) WAN or a wired WAN), which may, in turn, provide access to external networks including the Internet. For example, the intermediate device 212 may associate and communicate, over a Wi-Fi link 218 or a wired link, with an AP 102 of the communication network 200, which also may serve various STAs 104. In some implementations, the intermediate device 212 is an example of a network gateway, for example, an IoT gateway. In such a manner, the intermediate device 212 may serve as an edge network bridge providing a Wi-Fi core backhaul for the IoT network including the communication devices 214. In some implementations, the intermediate device 212 can analyze, preprocess and aggregate data received from the communication devices 214 locally at the edge before transmitting it to other devices or external networks via the Wi-Fi link 218 or the wired link. The intermediate device 212 also can provide additional security for the IoT network and the data it transports.

In some implementations of the communication network 200, reclassification of traffic flows may be triggered associated with ingress rates of traffic flows, traffic flows failing to satisfy SLAs, or both. In some implementations, a selective classification entity (operating as or within an intermediate device 212, a communication device 214, an AP 102, a STA 104, a CPE, a server device, an ISP device, a cloud-based platform or service, or any other wired or wireless device) may obtain information indicative of an ingress rate of a traffic flow of an application, with the traffic flow being associated with a first traffic class. An ingress rate of a traffic flow may be representative of a bitrate of a traffic flow that indicates or is otherwise associated with a rate at which data enters the communication network 200. For example, the information indicative of the ingress rate of the traffic flow of the application may include an indication of a change of a bitrate of a traffic flow (such as an increase in bitrate or a decrease in bitrate).

In some implementations, the selective classification entity may obtain an indication of a traffic flow associated with a first traffic class failing to satisfy an SLA of the traffic flow, with the failure of the SLA being associated with (such as caused by or a result of) a traffic flow congestion of a traffic flow queue. For example, the selective classification entity may operate as or within an intermediate device 212 and monitor an egress rate of a traffic flow, the egress rate being indicative of the failure to satisfy the SLA. In such implementations, an ingress rate may refer to a rate of data from the WAN and an egress rate may refer to a rate of data to the WLAN.

In some implementations, the selective classification entity (such as the intermediate device 212) may obtain such indications (such as from the AP 102 or the STA 104) and transmit (such as output, provide, or otherwise send) an instruction to a traffic classifier to perform a traffic classification for one or more traffic flows in accordance with the ingress rate, the egress rate, or both satisfying one or more triggering conditions (such as a threshold ingress rate change for a threshold duration, an SLA violation, or both). In some implementations, the instruction may be in accordance with a change of the ingress rate indicated by the information indicative of the ingress rate of the traffic flow. For example, the intermediate device 212 may determine that the change of the ingress rate (such as a bitrate) of a traffic flow is above an ingress rate threshold for a threshold duration, which may indicate that the traffic flow is to be reclassified. Additionally, or alternatively, the instruction may be in accordance with an egress rate of the traffic flow that indicates that a rate of traffic transmissions of the traffic flow is failing to satisfy a threshold rate indicated by an SLA, causing an SLA failure. For example, the intermediate device 212 may determine that the throughput level or latency of a traffic flow, a traffic flow queue, or both fail to satisfy threshold levels, indicating a failure of an SLA. In some implementations, such an SLA failure may result from a traffic flow being misclassified into an incorrect traffic flow queue, which may result in the traffic flow congestion. In some aspects, the selective classification entity may use egress rate-based (such as a traffic flow queue-based) (re)classification in scenarios in which a client device is a wireless device (such as in scenarios in which a traffic flow is output into a WLAN) and may not use egress rate-based (re)classification in scenarios in which the client device is a wired device (such as in scenarios in which the traffic flow is output to a client device via a wired connection). The selective classification entity may use an ingress rate-based (re)classification in scenarios in which a client device is a wireless device or a wired device (such as in scenarios in which a traffic flow is output into a WLAN or in which the traffic flow is output to the client device via a wired connection).

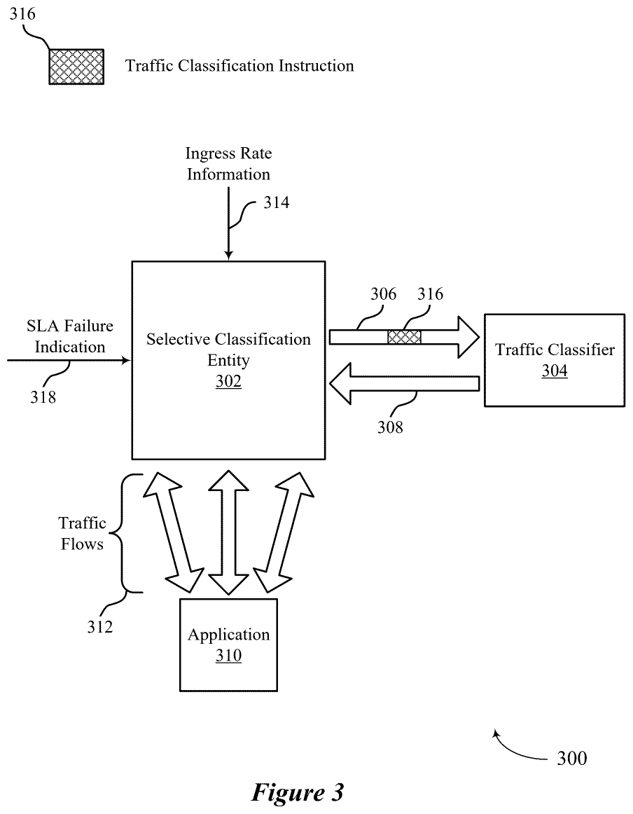

FIG. 3 shows an example of a signaling diagram 300 that supports triggered classification of a traffic flow. In some implementations, the signaling diagram 300 may implement or be implemented by the communication network 100, the communication network 200, or both. For example, the signaling diagram 300 may include a selective classification entity 302 and a traffic classifier 304, which be or be within an AP 102 or a STA 104, such as an AP 102 or a STA 104 illustrated by and described with reference to FIGS. 1 and 2. The selective classification entity 302 may communicate to the traffic classifier 304 via a communication link 306 and the traffic classifier 304 may communicate to the selective classification entity 302 via a communication link 308. The communication link 306 and the communication link 308 may be examples of wired communication links, wireless communication links, or any combination thereof.

In some implementations, the selective classification entity 302 may be an example of a wireless device (such as an AP 102 or a STA 104) or a component, entity, apparatus, or system within of a wireless device (such as an AP 102 or a STA 104). The selective classification entity 302 may further communicate with an application 310, which may have or otherwise be associated with one or more traffic flows 312. Each of the one or more traffic flows 312 may be associated with different QoS expectations, transmission characteristics, or a combination thereof. The one or more traffic flows 312 may enable the application 310 to obtain and output (receive and transmit) data packets across a wireless network, allowing for prioritization of different types of traffic across the wireless network.

In some implementations, as part of an establishment or an initiation of the application 310, the selective classification entity 302 may communicate with the traffic classifier 304 to selectively classify the one or more traffic flows 312 with respective traffic classes. In some implementations, a traffic class may represent a classification of a traffic flow and the traffic class may be associated with a respective priority level, among other characteristics unique to the traffic class. The traffic classifier 304 may be an example of an AI/ML model that is trained to classify the one or more traffic flows 312 in accordance with various traffic or transmission characteristics. For example, the traffic classifier 304 may perform a training procedure according to which a set of training data is fed into the AI/ML model of the traffic classifier 304. In some implementations, the set of training data may include example traffic or transmission characteristics of traffic flows and indications of an expected classification of the traffic flows associated with the example traffic or transmission characteristics. In accordance with the training procedure, the AI/ML model may learn the patterns or behaviors associated with the traffic or transmission characteristics that result in traffic flows being classified with respective traffic classes.

In some implementations, during communications associated with the application 310, the characteristics of at least one traffic flow of the one or more traffic flows 312 may change. For example, during a life cycle of a traffic flow of the one or more traffic flows 312, a traffic class may change after a given period of time. To classify each traffic flow of the one or more traffic flows 312 to a correct traffic class (and a correct priority level), the traffic classifier 304 may perform continuous reclassification on the one or more traffic flows 312. Performing continuous reclassification (which may involve continuous feature extraction for a traffic flow) at the traffic classifier 304, however, may result in a relatively large consumption of processing resources (such as computer processing unit (CPU) resources), networking resources, firmware resources, or any combination thereof. For example, a single traffic flow that is continuously reclassified by the traffic classifier 304 may result in an increase in CPU usage (such as about a 5% increase). Further, in scenarios in which each traffic flow of the one or more traffic flows 312 is continuously reclassified by the traffic classifier 304, a CPU associated with (such as used by) the traffic classifier 304 may experience a relatively large increase in CPU usage. For example, in scenarios in which the one or more traffic flows 312 are each high-performance traffic flows with traffic characteristics potentially changing relatively rapidly and with an expectation of low latency, the traffic classifier 304 may nearly constantly (re)run feature extraction (such as feature collection) and the AI/ML model associated with the traffic classification (such as an AI/ML model that includes, is based on, is associated with, or is otherwise in accordance with the feature extraction, such as one or more features collection algorithms) to suitably reclassify the traffic class of the one or more traffic flows 312. In other words, when a device reclassifies a flow, the device may (re)run both the traffic classifier 304 and the feature extraction, which may incur processing or computational costs at the device. Further, continuous feature extraction may expect that each of the one or more traffic flows 312 be within a software data path, which may render a corresponding hardware data path unusable. For example, while a statistics collection module or driver may be implemented within the software data path to perform continuous feature extraction, the hardware data path may have to be physically modified to continuously perform feature extractions, which may be relatively difficult, costly, and inefficient. Additionally, or alternatively, any changes in data patterns of the one or more traffic flows 312 or a single misclassification of one of the one or more traffic flows 312 may trigger a (relatively instantaneous or immediate) change in one or more QoS parameters associated with one or more traffic flows (including traffic flow queue), which may disrupt transmission timelines for the one or more traffic flows (and potentially from one or more traffic flow queues).

Reclassification techniques associated with such a continuous reclassification by the traffic classifier 304 may result in relatively large amount of resource consumption (such as use of a relatively large quantity of CPU cycles, a relatively large amount of memory, or a relatively large amount of any other one or more resources used to receive, transmit, or classify traffic), which may introduce increased latency and decreased efficiency and reliability of a wireless network. To reduce or mitigate such resource consumption associated with traffic (re)classification, the selective classification entity 302 may selectively trigger a (re)classification of the one or more traffic flows 312 by monitoring both ingress and egress data, individually or in combination. In some implementations, the selective classification entity 302 may receive ingress rate information 314 associated with the one or more traffic flows 312 and the selective classification entity 302 may output a traffic classification instruction 316 to the traffic classifier 304 in accordance with the ingress rate information 314 satisfying a triggering condition or criterion. In such implementations, the traffic classifier 304 may run (such as perform) the traffic classification in accordance with a (re)classification decision, the (re)classification decision (that is, the decision on whether to perform the traffic classification) utilizing a relatively small amount of data (such as minimal data) as compared to the amount of data that may be acquired and processed as part of a complete feature extraction. For example, the selective classification entity 302 may decide to trigger a traffic (re)classification using the ingress rate information 314. Thus, rather than the traffic classifier 304 attempting to perform (re)classification at all times with continuous feature extraction, the traffic classifier 304 may refrain from performing feature extraction and refrain from performing (re)classification until a trigger is received, resulting in the traffic classifier 304 consuming relatively fewer resources as compared to scenarios in which the traffic classifier 304 performs continuous feature extraction and (re)classification. For example, without the trigger, the traffic classifier 304 may continuously perform feature extraction and (re)classification, which may result in a relatively large amount of resources being consumed. In other words, an overall cost and amount of resources consumed by the traffic classifier 304 may be reduced in accordance with the selective classification entity 302 selectively instructing at which times the traffic classifier 304 is to perform a feature extraction and a traffic (re)classification.

Traffic (re)classification that is instructed in accordance with the ingress rate information 314 may be associated with a pre-emptive detection that a traffic (re)classification may be suitable (such as result in lower latency, higher data rates, or greater user experience scores). For example, in accordance with obtaining the ingress rate information 314, the selective classification entity 302 and the traffic classifier 304 may be capable of detecting potential QoS breaches prior to a QoS breach occurring. A QoS breach may refer to a traffic flow or a traffic flow queue (associated with a traffic class) failing to satisfy an SLA of the traffic flow or the traffic flow queue. For example, an SLA of a traffic flow or a traffic flow queue may indicate one or more QoS expectations of the traffic flow or the traffic flow queue (such as latency expectations, throughput expectations, or reliability expectations, among other example QoS expectations).

In some implementations, the selective classification entity 302 may utilize one or more components or communicate with one or more components of a device (such as an AP 102 or a STA 104) to collect traffic volume data with respect to time. Utilizing the traffic volume data, the selective classification entity 302 may be capable of detecting a change in a traffic pattern of a traffic flow of the one or more traffic flows 312. In some implementations, the selective classification entity 302 may obtain an indication of the change in the traffic pattern via the ingress rate information 314, as the change in the traffic pattern may represent a change in the ingress rate of a traffic flow. For example, a real-time traffic flow (such as a voice traffic flow, a video traffic flow, a game traffic flow, or the like) may experience a relatively large increase or decrease in ingress rate indicating that the traffic class of the real-time traffic flow is to be reclassified. In an online gaming scenario, a change in a traffic pattern or ingress rate of a traffic flow may be associated with a change in the game. For example, the bitrate of a traffic flow may initially be relatively low when a user or a player is in a lobby of a game selecting one or more options (such as selecting a character to use). Once the game starts, the traffic flow may start to include relatively larger quantities of data transmissions and the bitrate or ingress rate of the traffic flow may increase relatively rapidly.

In some implementations, the triggers for the reclassifications may be associated with the change of the ingress rate of a traffic flow satisfying an ingress rate threshold. Further, in some implementations, the selective classification entity 302 and the traffic classifier 304 may be configured with one or more ingress rate thresholds and one or more reclassification priorities associated with one or more traffic classes. In other words, each traffic class may be associated with a respective ingress rate threshold or a respective reclassification priority, or both. In some implementations, the one or more ingress rate thresholds may be associated a threshold increase of the ingress rate, a threshold decrease of the ingress rate, a threshold duration since a previous increase or decrease of the ingress rate (such as a time series of ingress rate change), or any combination thereof. For example, for bursty traffic (such as livestream traffic flows and video stream traffic flows), in scenarios in which a change of the ingress rate of a traffic flow is not detected or observed for a threshold duration (such as 5, 10, or 30 seconds, etc.), the selective classification entity 302 may trigger the traffic classifier 304, via the traffic classification instruction 316, to perform a reclassification of the traffic flow.

In some implementations, the selective classification entity 302 may determine to output the traffic classification instruction 316 in accordance with a traffic class of a traffic flow of the one or more traffic flows 312. For example, the selective classification entity 302 may determine to output a traffic classification instruction 316 in accordance with a change of an ingress rate satisfying an ingress rate threshold for a threshold duration, with the threshold duration being associated with the change of the ingress rate, the traffic class of the traffic flow, or both. In some implementations, the threshold duration may be associated with a direction of the change of the ingress rate, a magnitude of the change of the ingress rate, or both. For example, in an online gaming scenario a traffic flow that changes from a voice traffic flow to a gaming traffic flow, the ingress rate information 314 may indicate an increase in ingress rate due to an increase in the throughput of the traffic flow. In such implementations, the selective classification entity 302 may trigger the traffic classifier 304, via the traffic classification instruction 316, to perform the traffic classification relatively instantly. In other words, for real-time traffic, an increase or decrease (such as an increase or decrease by a threshold amount) in ingress rate may (approximately instantly) trigger the traffic classification instruction 316.

By way of further example, in scenarios in which the ingress rate information 314 indicates a decrease in the ingress rate, the selective classification entity 302 may wait a threshold duration (such as 30 seconds) before triggering the reclassification of a traffic flow via the traffic classification instruction 316. For example, if the ingress rate, the throughput, or both, of a traffic flow increases before expiration of the threshold duration, the selective classification entity 302 may refrain from triggering the traffic classifier 304 to reclassify the traffic flow. Therefore, for ingress rate or throughput increases, the selective classification entity 302 may trigger the traffic classifier 304 to perform reclassification of a traffic flow (nearly) instantly (such that a threshold duration is equal to zero or approximately zero), and for ingress rate or throughput decreases, the selective classification entity 302 may delay triggering the traffic classifier 304 to perform the reclassification of a traffic flow until after a (non-zero) threshold duration.

By implementing such threshold durations, the selective classification entity 302 may be capable of preventing a change in the traffic class of a traffic flow back and forth relatively rapidly. In some implementations, different threshold durations may be associated with (such as used in) different conditions or scenarios (such that a threshold duration may correspond to a specific ingress rate behavior). For example, while the selective classification entity 302 may trigger the traffic classifier 304 to perform a (re)classification approximately instantaneously after an ingress rate increase, the selective classification entity 302 may wait until after a threshold duration to trigger the traffic classifier 304 to perform a (re)classification after detecting an ingress rate decrease. By way of further example, a first threshold duration for voice traffic experiencing a decrease in ingress rate may be relatively longer as compared to a second threshold duration for voice traffic experiencing an increase in ingress rate and as compared to a third threshold duration for gaming traffic experiencing a decrease in ingress rate. In some aspects, the second threshold duration or the third threshold duration may be equal to zero or approximately equal to zero (such as within a threshold quantity of milliseconds from zero, with the threshold quantity of milliseconds being, for example, 1 millisecond). Additionally, or alternatively, a threshold duration may correspond to a configuration (such as a setting or behavior) of the selective classification entity 302 or the traffic classifier 304. For example, instead of or in addition to a threshold duration being defined for one or both of a specific traffic class or a specific ingress rate behavior, the threshold duration may be set in accordance with whether the selective classification entity 302 or the traffic classifier 304 is configured to (re)classify traffic relatively more aggressively (such as relatively more frequently) or relatively more passively (such as relatively less frequently). In such examples, a relatively more aggressive (re)classifier may skip a threshold duration (such that the threshold duration may be set equal to zero or approximately zero) and a relatively more passive (re)classifier may use a non-zero threshold duration.

In some implementations, the selective classification entity 302 may utilize a confidence level with the ingress rate information 314 to determine whether a traffic flow of the one or more traffic flows 312 is to be reclassified. For example, as shown in Table 1 below, the selective classification entity 302 may determine whether to output the traffic classification instruction 316 to the traffic classifier 304 in accordance with a confidence score associated with an initial classification, the ingress rate or throughput behavior, and the traffic class of a traffic flow. In some implementations, the term “confidence” may be indicative of a metric or ranking of a quality of the output from an AI/ML model (such as the traffic classifier 304). Further, the confidence may be associated with one or more parameters such as a prediction probability, entropy, or any combination thereof. Further, the generation of the confidence level may differ in accordance with an initial classification of a traffic flow of the one or more traffic flows 312 and how the traffic flow is initially classified. For example, the AI/ML model associated with the traffic classifier 304 may generate a confidence score for each traffic classification performed and how the confidence score is generated may be associated with the type of AI/ML model, the training of the AI/ML model, and the like.

TABLE 1

| Throughput/Ingress | Initial | Confidence | |
|---|---|---|---|
| Rate Behavior | Classification | Threshold | Reclassify? |
| Increase | Real-time | N/A | Yes |
| Decrease | Real-time | Confidence ≤0.6 | Yes |
| Decrease | Real-time | Confidence >0.6 | No |
| No burst in X | Burst | Confidence ≤0.6 | Yes |
| seconds | | | |
| No burst in X | Burst | Confidence >0.6 | No |
| seconds | | | |

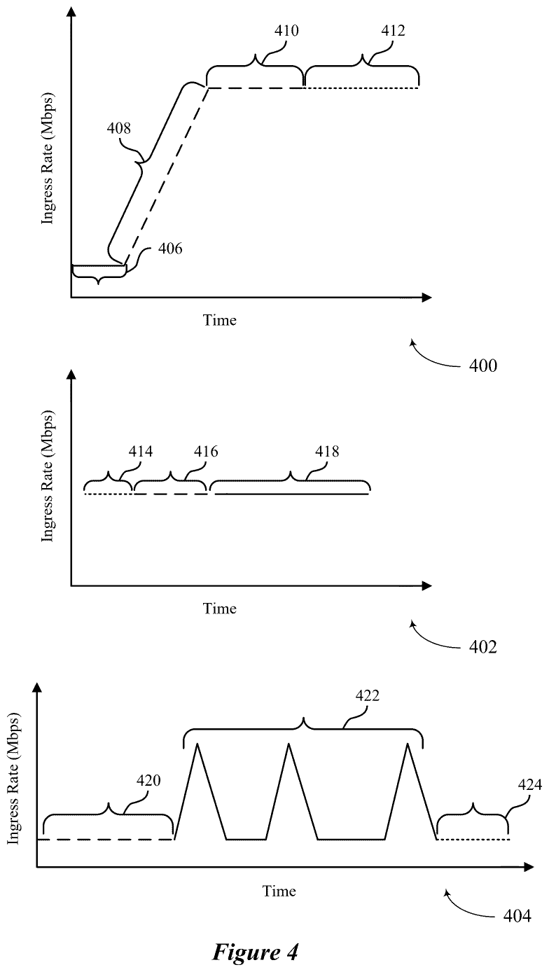

As illustrated in Table 1 above, the selective classification entity 302 may determine whether a traffic flow of the one or more traffic flows 312 is to be reclassified in accordance with the direction of a change of the ingress rate, a traffic class that the traffic flow is initially classified as, and whether a confidence score satisfies a confidence score threshold. For example, as shown in the second row of Table 1, a traffic flow may be initially classified by the traffic classifier 304 as being associated with a real-time traffic class and the traffic classifier 304 may generate a confidence score below a confidence score threshold. In such implementations, if the ingress rate information 314 indicates that the change of the ingress rate of a traffic flow is a decrease, the selective classification entity 302 may determine to output the traffic classification instruction 316 to the traffic classifier 304. For example, in accordance with the confidence score of the initial classification failing to satisfy the confidence score threshold, the selective classification entity 302 may determine that the initial classification may be a misclassification and the decrease in throughput or ingress rate of the traffic flow may provide an opportunity to reclassify the traffic flow. Similarly, in the third row of Table 1, if the confidence score for a traffic flow being initially classified as being associated with the real-time traffic class satisfies the confidence score threshold, the selective classification entity 302 may refrain from triggering a reclassification. Additional details of the techniques associated with the selective classification entity 302 obtaining the ingress rate information 314 and utilizing the ingress rate information 314 to trigger a traffic (re)classification on the one or more traffic flows 312 are described elsewhere herein, including with reference to FIGS. 4-5 and 9A-11.

In some implementations, for firmware- or egress-based traffic (re)classification techniques, the selective classification entity 302 and the traffic classifier 304 may trigger and perform, respectively, traffic classification in accordance with QoS breaches that are identified (such as detected, measured, or otherwise determined) as being due to an internal cause. An internal cause may be or may include traffic flow congestion. For example, the selective classification entity 302 may obtain or receive an SLA failure indication 318 that indicates a failure to satisfy an SLA associated with a traffic flow of the one or more traffic flows 312 and, in some scenarios, the failure to satisfy the SLA may be associated with (such as caused by) a traffic flow congestion of at least one traffic flow queue of a set of traffic flow queues. The selective classification entity 302 may output or transmit the traffic classification instruction 316 to the traffic classifier 304 to perform the traffic classification of the traffic flow in accordance with the SLA failure indication 318 and that the failure indicated via the SLA failure indication 318 is associated with (or otherwise in accordance with or caused by) the traffic flow congestion.

Traffic flows and traffic flow queues may be associated with (such as defined with) a throughput SLA, a latency SLA, or both. When a traffic flow or a traffic flow queue is associated with a throughput or latency that fails to satisfy the throughput SLA or the latency SLA, respectively, the traffic flow or the traffic flow queue may be associated with (such as have or cause) a QoS breach. A QoS breach, such as a failure to satisfy an SLA (which may be referred to as an SLA violation), may be due to internal or external causes. For example, a QoS breach that is associated with (such as caused by) traffic flow congestion may have an internal cause and a QoS breach that is associated with (such as caused by) external noise in a network may have an external cause. In some implementations, the selective classification entity 302 may output or transmit the traffic classification instruction 316 to the traffic classifier 304 in scenarios in which a QoS breach or an SLA violation is due to an internal cause and may refrain from outputting or transmitting the traffic classification instruction 316 to the traffic classifier 304 in scenarios in which the QoS breach or the SLA violation is due to an external cause.

In some implementations, such techniques of traffic reclassification may reduce the quantity of data used to determine at which times to (re)classify a traffic flow of the one or more traffic flows 312. For example, the traffic classifier 304 may utilize the SLA failure indication 318 and data associated with the SLA failure to determine whether to perform a traffic (re)classification. Moreover, such techniques of traffic classification may bean example of reactive detection. For example, the selective classification entity 302 may output the traffic classification instruction 316 in accordance with an QoS breach associated with an SLA failure occurring. By utilizing the SLA failure indication 318 to trigger a traffic (re)classification, the selective classification entity 302 and the traffic classifier 304 may reclassify any of the one or more traffic flows 312 relatively quickly (such as with low latency). For example, once a state of QoS breach is detected, the selective classification entity 302 may instruct the traffic classifier 304 to perform a traffic (re)classification procedure relatively quickly using AI traffic (re)classification.

In some implementations, each traffic flow of the one or more traffic flows 312 may be assigned a service class and may be assigned to a respective traffic flow queue to increase a likelihood that the SLA of each of the one or more traffic flows 312 is satisfied. In scenarios in which a traffic flow queue becomes too congested (such as if there are too many traffic flows assigned to a traffic flow queue), traffic flows, traffic flow queues, or both may fail to satisfy one or more SLAs. In some implementations, SLAs described herein may refer to SLAs of respective traffic flows (with each of the one or more traffic flows 312 having a respective (different) SLA), SLAs of respective traffic flow queues (with each of a set of traffic flows in a same traffic queue having a same SLA), or any combination thereof.

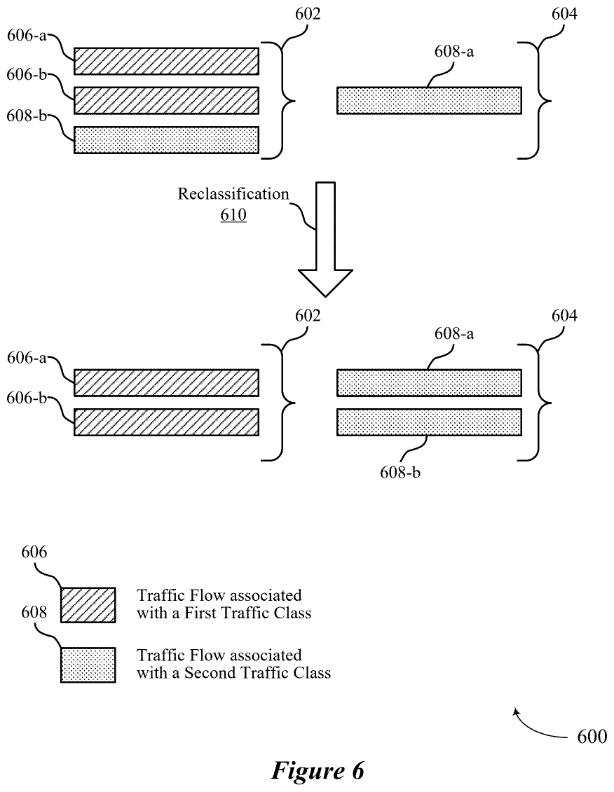

In some implementations, to determine whether the cause of a QoS breach (the cause of the failure to satisfy the SLA indicated via the SLA failure indication 318) is internal or external, the selective classification entity 302 may monitor packet retry or retransmission statistics, modulation and coding scheme (MCS) drops (such as a decrease in MCS), or any combination thereof, for each traffic flow queue. For example, relatively high quantities of packet retransmissions or MCS drops may be indicative of noise in a wireless network that can cause a QoS breach or failure to satisfy an SLA (rather than congestion), and the selective classification entity 302 may refrain from triggering a traffic (re)classification in scenarios in which noise in the wireless network causes the QoS breach or the failure to satisfy the SLA (as the traffic classifier 304 may be unable to mitigate noise in the wireless network). If the selective classification entity 302 determines that a traffic flow fails to satisfy an SLA associated with the traffic flow due to internal causes (such as internal firmware queue congestion), the selective classification entity 302 may trigger the traffic classifier 304, via the traffic classification instruction 316, to reclassify the traffic flow. Additionally, or alternatively, if during a reclassification procedure the traffic classifier 304 determines that a traffic flow was initially misclassified, the traffic flow may be moved to a different queue to free up bandwidth in a priority queue. Additional details of the techniques related to the selective classification entity 302 obtaining the SLA failure indication 318 and utilizing the SLA failure indication 318 to trigger a traffic (re)classification of the one or more traffic flows 312 are described elsewhere herein, including with reference to FIGS. 6-11.

FIG. 4 shows examples of an ingress rate timeline 400, an ingress rate timeline 402, and an ingress rate timeline 404 that support triggered classification of a traffic flow. In some implementations, the ingress rate timeline 400, the ingress rate timeline 402, and the ingress rate timeline 404 may implement or be implemented by the communication network 100, the communication network 200, the signaling diagram 300, or any combination thereof. For example, the ingress rate timeline 400, the ingress rate timeline 402, and the ingress rate timeline 404 may represent changes in ingress rate over time for traffic flows utilized by corresponding devices or components of corresponding devices described herein with reference to FIG. 1.

In some implementations, the ingress rate timeline 400, the ingress rate timeline 402, and the ingress rate timeline 404 may represent reclassification techniques of traffic flows that are initially misclassified or change behaviors (such as transmission or traffic characteristics) from an initial traffic class to a target traffic class. In some implementations, such reclassification techniques may include the selective classification entity 302, as illustrated by and described with reference to FIG. 3, obtaining an indication of the change of the ingress rate illustrated in the ingress rate timeline 400, the ingress rate timeline 402, the ingress rate timeline 404, or any combination thereof to trigger reclassification of traffic flows. The traffic classifier 304, as also illustrated by and described with reference to FIG. 3, may perform the traffic classification of the traffic flows in accordance with an instruction from the selective classification entity 302.

In some implementations, a traffic flow may initially be classified with a first traffic class (such as a background traffic class) and the classification may be a misclassification or behaviors and characteristics of the traffic flow may change to that of a second traffic class (such as a target traffic class). In some implementations, to reclassify the traffic flow, the traffic classifier 304 may perform rate change based reclassification or bound based reclassification. For rate change based reclassification, the selective classification entity 302 may trigger the traffic classifier 304 (such as an AI/ML model trained to perform traffic flow classification) to reclassify a traffic flow in accordance with a change of the ingress rate of the traffic flow satisfying an ingress rate threshold (such as at least one ingress rate threshold of a set of ingress rate thresholds). In some implementations, in accordance with the direction (such as an increase or a decrease in ingress rate), magnitude (such as a quantity of an increase or decrease in any units of data rate), or both, the selective classification entity 302 may trigger the traffic classifier 304 in accordance with the change of the ingress rate of the traffic flow satisfying the ingress rate threshold for a threshold duration.

In some implementations, the threshold duration may be associated with the direction of the change of the ingress rate, the magnitude of the change of the ingress rate, the initial traffic class of the traffic flow, a target traffic class, or any combination thereof. For example, the threshold duration may be associated with a first quantity of time domain units (such as seconds, milliseconds, nanoseconds, or the like) in accordance with the direction of the change of the ingress rate being an ingress rate decrease. Further, the threshold duration may be associated with a second quantity of time domain units in accordance with the direction of the change of the ingress rate being an ingress rate increase rate. Additionally, or alternatively, the second quantity of time domain units may be less than the first quantity of time domain units. That is, the threshold duration that a change of an ingress rate of a traffic flow that the traffic flow may have to satisfy an ingress rate threshold hold for may be longer for an ingress rate decrease than for an ingress rate increase. For example, the threshold duration may be zero time domain units (such as zero seconds) in accordance with the direction of the change of the ingress rate being an ingress rate increase and the magnitude of the change of the ingress rate satisfying a threshold magnitude.

In some implementations, for bound based reclassification, the selective classification entity 302 may trigger the traffic classifier 304 to reclassify a traffic flow in accordance with upper and lower ingress rate bounds. For example, if a change of the ingress rate of a traffic flow moves from outside a first set of ingress rate bounds to inside a second set of ingress rate bounds, the selective classification entity 302 may trigger the traffic classifier 304 to reclassify the traffic flow. By way of further example, if a traffic flow that is associated with a background traffic class, the traffic flow has not been reclassified, and the ingress rate of the traffic remains within a set of ingress rate bounds for a threshold duration, the selective classification entity 302 may trigger the traffic classifier 304 to reclassify the traffic flow. Additionally, or alternatively, for bursty traffic (such as traffic flows that experience (relatively frequent) ingress rate increases and ingress rate decreases), if a traffic flow has similar behavior (such as a traffic or transmission character) as a respective traffic class, the selective classification entity 302 may trigger the traffic classifier 304 to reclassify the traffic flow. In such implementations, the selective classification entity 302 may observe, for a traffic flow, the throughput or ingress rate increases with respect to time, the throughput or ingress rate decreases with respect to time, and a total time of execution to determine whether to trigger the traffic classifier 304 to reclassify the traffic flow.

In some implementations, the ingress rate timeline 400 may illustrate the reclassification of a traffic flow that is initially classified as being associated with a first traffic class (such as a background traffic class) and the initial classification is a misclassification, the behavior of the traffic flow changes, or both. For example, at 406, after an initial establishment of a traffic flow (such as after 3 seconds), the traffic flow may be initially classified with a first traffic class (such as a background traffic class). At 408 (such as from 3 seconds to 6 seconds), the ingress rate of the traffic flow may increase but may still be classified as being associated with the first traffic class. At 410 (such as at the 6 seconds mark), the ingress rate of the traffic flow may meet the ingress rate bounds for a second traffic class. At 412, in scenarios in which the traffic flow remains within the ingress rate bounds associated with the second traffic class for a threshold duration (such as 3 seconds), the selective classification entity 302 may trigger a traffic classifier 304 to perform a traffic (re)classification. By way of example, the second traffic class may have a lower ingress rate bound of 9 megabits per second (Mbps) and an upper ingress rate bound of 11 Mbps and, at 410, the ingress rate of the traffic flow may be at 10 Mbps. In some implementations, the time at 410, before the traffic flow is reclassified from being associated with the first traffic class to being associated with the second traffic class, may be associated with the traffic flow remaining within the ingress rate bounds of the second traffic class for a threshold duration (such as 3 seconds). Additionally, or alternatively, the time at 410 before the traffic flow is reclassified may be associated with a filtering time (such as 3 seconds) to collect data for performing the (re)classification. At 412, the traffic flow may be reclassified to the second traffic class.

In some implementations, the first traffic class may be representative of a background traffic class and the second traffic class may be representative of a video traffic class. For example, a user may begin or join a video call and may initially leave a camera off and further switch the camera on after a period of time. In such implementations, a video-based traffic flow may remain active and just at a relatively low bitrate as to keep the flow active with the assistance of different codecs but a traffic classifier 304 may misclassify the traffic flow as a background flow. Thus, when the user turns the camera on, the bitrate may increase relatively rapidly and in accordance with the change of the bitrate, the selective classification entity 302 may trigger the traffic classifier 304 to reclassify the flow. Further, the traffic classifier 304 may obtain the information in accordance with the change and reclassify the traffic flow to be associated with a video traffic class to support the relatively higher data traffic and priority level when the camera is on compared to having the camera off.

In some other implementations, a user may initially turn a camera on during a video call and after a few minutes the user may switch the camera off for the rest of the meeting. In such implementations, the traffic classifier 304 may initially classify the traffic flow as being associated with a video traffic class associated with an initial set of parameters and a MAC service data unit queue (MSDUQ) may be generated for the video-based traffic flow. However, the MSDUQ may remain active even after the camera of the user is turned off which may be unnecessary and can result in wasting a relatively large quantity of processing resources. Therefore, in accordance with the techniques of the present disclosure, in accordance with detection of a relatively lower bitrate when the camera is off (such as a decrease in the ingress rate of the traffic flow), the selective classification entity 302 may trigger the traffic classifier 304 to reclassify the traffic flow to reduce the quantity of processing resources being consumed for the traffic flow. Moreover, the selective classification entity 302 may wait until the camera has been off for a threshold duration before triggering the reclassification to avoid unnecessary reclassifications if the user only turns the camera off for a relatively short period of time.

By way of further example, the second traffic class may represent a voice traffic class. For example, during a voice call or a video call, a user or a meeting may be on mute during an initial part of a meeting (such as when a user is waiting for others to join a call to start the meeting). Further, after a period of time, one or more users may unmute their microphones and begin voice chats. Similar to video calls, when joining the call, a voice flow may be active even while a microphone is off but at a relatively low bitrate that is just enough to keep the flow active with the assistance of different codecs. When the user turns a microphone on, the bitrate may increase accordingly. During the time the microphone is off, the traffic classifier 304 may classify the traffic flow as being associated with a background traffic class due to the initial behavior of the traffic flow (such as relatively low bitrates or ingress rates that are below a threshold level). When the user turns the microphone on, the traffic flow may be misclassified as a background traffic class rather than a voice traffic class. In some implementations, in accordance with detecting the increase in the bitrate or ingress rate, the selective classification entity 302 may trigger the traffic classifier 304 to reclassify the traffic flow (such that the traffic flow may be reclassified to be associated with the voice traffic class).

In some other implementations, the traffic patterns of a traffic flow may change over time during the operation of an application, such as when a user is playing an online game. For example, the bitrate of a traffic flow may initially start relatively low while a user is in a first stage of a game such as a game lobby where the user is picking a character to play and is not interacting with other users via wired or wireless communications. During this stage, due to the bitrate being relatively low (such as be around 130-160 Kbps), the traffic classifier 304 may misclassify the traffic flow as being associated with first traffic class (such as a background traffic class or a voice traffic class) rather than a second traffic class (such as a game traffic class). Once the game starts and the user begins to interact with other users via wireless communications, the bit rate may increase accordingly but the traffic flow may be classified as something other than being associated with a game traffic class (such as being associated with a background traffic class or a voice traffic class) associated with the initial behavior of the traffic flow. In accordance with the bitrate or the ingress rate increase, the selective classification entity 302 may trigger the traffic classifier 304 to reclassify the traffic flow to be associated with a game traffic class to provide an increase in support and priority for the traffic flow compared to being associated with a voice traffic class or a background traffic class.

By way of further example, a user may pause the game in the middle and take a relatively long break without exiting or closing the application due the time to restart the game. During this time, an MSDUQ that is generated for the traffic flow that is associated with the game traffic class may remain active due to the traffic flow being active (the traffic flow being active in accordance with the application still being open). As such, the quantity of resources consumed by the traffic flow may be relatively high even though the traffic flow is associated with a relatively low bitrate or ingress rate during the pause period. In accordance with the techniques of the present disclosure, in accordance with the decrease in the bitrate or ingress rate for a threshold duration, the selective classification entity 302 may reclassify the traffic flow from being associated with the second traffic class (such as a game traffic class) to being associated with the first traffic class (such as a background traffic class).

In some implementations, the traffic classifier 304 may misclassify a traffic flow at an initial classification stage. For example, as illustrated via the ingress rate timeline 402, at 414, after an initial establishment of a traffic flow (such as after about 3 seconds from the initial establishment), the traffic classifier 304 may initially classify the traffic flow as being associated with a first traffic class (such as a background traffic class). At 416, the selective classification entity 302 may determine that after a threshold duration (such as a threshold duration, or filter time, that is greater than a threshold duration used for the variable data pattern associated with the ingress rate timeline 400) data collection for the traffic flow may be retriggered, as the initial classification of the traffic flow may be a misclassification. At 416, while the traffic flow may be classified as being associated with the first traffic class, after a filter time period (such as 7 second), the data collection may be retriggered for the traffic classifier 304 to reclassify the traffic flow. At 418, the traffic classifier 304 may classify the traffic flow as being associated with a second traffic class that is in accordance with the characteristics of the traffic flow. For example, the ingress rate of the traffic flow may remain between a lower ingress rate bound and an upper ingress rate bound associated with the second traffic class for a threshold duration, thus indicating that the initial classification may have been a misclassification, and the traffic flow is to be associated with the second traffic class.

In some other implementations, the traffic flow may change characteristics or behaviors after an initial classification of the traffic flow. For example, as illustrated via the ingress rate timeline 404, at 420, after a duration, the traffic classifier 304 may classify a traffic flow as being associated with a first traffic class (such as a background traffic class). At 422, the behavior and characteristics of the traffic flow may change, and a selective classification entity 302 may observe bursts where the change of the ingress rate of the traffic flow satisfies a delta ingress rate threshold, a time threshold, or both. For example, at 422, the selective classification entity 302 may observe that the traffic flow has one or more ingress rate bursts that are representative of a second traffic class. At 424, a traffic classifier 304 may reclassify the traffic flow to be associated with the second traffic class (such as a video stream traffic class, a live cast traffic class, or a combination thereof).

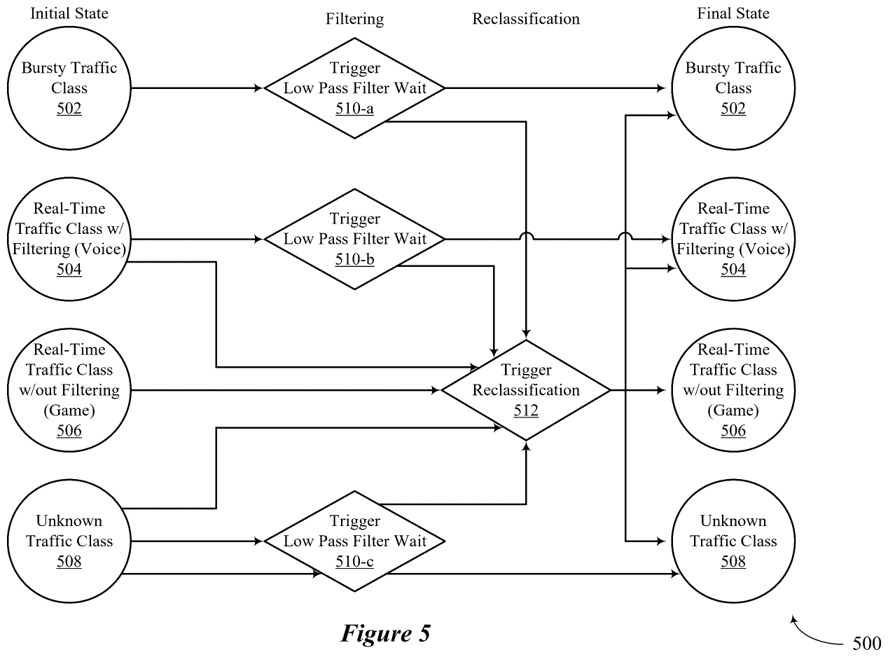

The selective classification entity 302 may trigger the traffic classifier 304 to reclassify the traffic flow in accordance with the changes in the behavior or characteristics of the traffic flow to ensure that the traffic flow is associated with a correct priority level. For example, a traffic flow that is a video stream traffic flow but is originally classified as a background traffic flow may experience one or more performance issues such as buffering or video freezes that can result in a reduction in efficiency and reliability of a wireless network. In accordance with example implementations disclosed herein, the traffic classifier 304 may be triggered to reclassify traffic flows in accordance with ingress rate changes to increase a likelihood that each traffic flow is correctly classified and has the priority level support to support reliable communications associated with the traffic flow. Additional details of the techniques associated with traffic flows changing from an initial classification to a target classification are described elsewhere herein, including with reference to FIG. 5.

FIG. 5 shows an example of flowchart 500 that supports triggered classification of a traffic flow. In some implementations, the flowchart 500 may implement or be implemented by the communication network 100, the communication network 200, the signaling diagram 300, or any combination thereof. For example, the flowchart 500 may illustrate reclassification of traffic flows utilized by an AP 102 or a STA 104, such as an AP 102 or a STA 104 illustrated by and described with reference to FIGS. 1 and 2. In some implementations, the flowchart 500 may represent traffic flows being reclassified in accordance with ingress rate triggers and filtering to ensure that a traffic flow is associated with a correct traffic class in accordance with the traffic patterns, behaviors, characteristics, or any combination thereof of a traffic flow. By ensuring that each traffic flow is associated with a correct traffic class, each traffic flow may be associated with a correct priority level and resource consumption level to prevent increases in latency and increases in unnecessary resource consumption within a wireless network due to misclassification of traffic flows. In some aspects, the selective classification entity 302 and the traffic classifier 304, as illustrated by and described with reference to FIG. 3, may perform one or more operations of the flowchart 500.

In some implementations, a traffic flow may be initially classified as being associated with a respective traffic class. In some implementations, an initial classification of a traffic flow may be that the traffic flow is associated with a first traffic class 502 (such as a bursty traffic class), a second traffic class 504 (such as a real-time traffic class with filtering which can represent a voice traffic class), a third traffic class 506 (such as a real-time traffic class without filtering which can represent a game traffic class), or any combination thereof. In some other examples, an initial classification of a traffic flow may be an unknown traffic class 508 (such as a background traffic class).

In some implementations, while four traffic class types are shown as initial states of a traffic flow, there may be more or less types of traffic classes that a traffic classifier 304 can initially classify a traffic flow as being associated with. For example, a traffic flow can be classified with a video traffic classification, a voice traffic classification, a game traffic classification, a video stream classification, a live cast classification, one or more classification types associated with an AI/ML model, a background traffic classification, an unknown traffic classification, or any combination thereof. In some aspects, one or more ingress rate thresholds may be associated with (such as defined for) each traffic class and the selective classification entity 302 may compare an ingress rate change for a traffic flow to at least one ingress rate threshold associated with a traffic class as part of determining whether to instruct a traffic classification for the traffic flow. The traffic class associated with the at least one ingress rate threshold to which the ingress rate change is compared may be a traffic class that the traffic flow is currently classified in or another traffic class depending on the scenario (such as depending on the traffic class that the traffic flow is currently classified in, a nature of the ingress rate change, which type of ingress rate threshold is used, or any combination thereof). For example, the selective classification entity 302 may compare an ingress rate of a real-time traffic to a threshold raw ingress rate increase associated with the real-time traffic. By way of further example, the selective classification entity 302 may compare an ingress rate of a “buffery” traffic (such as traffic that involves packet buffering, which may be equivalently understood as “bursty” traffic) to a threshold magnitude ingress rate increase associated with the “buffery” traffic. By way of further example, the selective classification entity 302 may compare an ingress rate of a background traffic to upper and lower ingress rate bounds associated with one or more target (such as non-background) classes. Further, the different traffic classes may be associated with traffic class groups that each include a respective set of traffic classes and are associated with a respective ingress rate threshold, a respective threshold duration, or both that triggers a traffic classification instruction.

In some implementations, a traffic flow may initially be classified as being associated with the first traffic class 502. Further, the selective classification entity 302 may obtain an indication of an ingress rate trigger for the traffic flow that indicates that the ingress rate is in accordance with real-time behavior. For example, the ingress rate of the traffic flow may change relatively often as expected for a video streaming application. The selective classification entity 302 may use trigger a low pass filter wait 510-a period to see if bursts are observed. If bursts are observed (within a threshold duration), the selective classification entity 302 may refrain from triggering a reclassification and traffic flow may remain associated with the first traffic class 502. If bursts are not observed (for the threshold duration), the selective classification entity 302 may further trigger the reclassification 512. In some implementations, triggering the reclassification 512 may include the selective classification entity 302 triggering the traffic classifier 304 (such as an AI/ML model trained to classify traffic flows) to perform a reclassification by outputting the ingress rate trigger to the traffic classifier 304. In response, the traffic classifier 304 may reclassify the traffic flow to be associated with the second traffic class 504, the third traffic class 506, or the unknown traffic class 508.

In some implementations, a traffic flow may initially be classified as being associated with the second traffic class 504. In some implementations, the selective classification entity 302 may obtain an ingress rate trigger (such as information indicative of an ingress rate associated with the traffic flow) that indicates that a change of the ingress rate of the traffic flow. In some implementations, the change of the ingress rate of the traffic flow may be that the ingress rate decreases by a traffic class threshold or increases by a traffic class threshold. For example, each traffic class may be associated with one or more ingress rate thresholds. In some implementations, the one or more ingress rate thresholds may be associated with a direction of a change of the ingress rate, a magnitude of the change of the ingress rate, or both. In some other implementations, the one or more ingress rate thresholds may include a lower ingress rate bound threshold and an upper ingress rate bound threshold. Further, if the ingress rate trigger indicates that the ingress rate of the traffic flow decreases by the traffic class threshold, the selective classification entity 302 may trigger a low pass filter wait 510-b period to observe if the ingress rate returns to an expected value or within an expected range associated with the second traffic class 504. If the ingress rate of the traffic flow returns to an expected ingress rate value, the selective classification entity 302 may refrain from triggering the reclassification 512 and the traffic flow may remain associated with the second traffic class 504. In examples in which a traffic pattern of the traffic flow is unable to return to be within the expected bounds of the second traffic class 504 or if the ingress rate trigger indicates an ingress rate increase, the selective classification entity 302 may trigger the reclassification 512 via the traffic classifier 304 by outputting the ingress rate trigger to the traffic classifier 304. In examples in which the ingress rate trigger indicates an ingress rate increase, the selective classification entity 302 may bypass the low pass filter wait 510-b and directly trigger the reclassification 512.

In some implementations, a traffic flow may initially be classified as being associated with the third traffic class 506. In some implementations, the selective classification entity 302 may obtain an ingress rate trigger that indicates an ingress rate increase or decrease by the traffic class threshold. In some implementations, because the third traffic class 506 may be associated with a relatively high priority and may be associated with a relatively large resource consumption level, in accordance with the ingress rate trigger, the selective classification entity 302 may trigger the reclassification 512 via the traffic classifier 304 to determine if the traffic flow is to be reclassified. For example, waiting a period of time before triggering the reclassification 512 may result in a relatively large quantity of resources being consumed if the traffic flow is misclassified such that the selective classification entity 302 may refrain from applying any filter to reduce the resource consumption of traffic flows that are misclassified.

In some implementations, a traffic flow may initially be classified as being associated with the unknown traffic class 508. The unknown traffic class 508 may represent that a traffic classifier 304 refrains from classifying a traffic flow initially. For example, the traffic classifier 304 may refrain from classifying a traffic flow until a change occurs. In some other implementations, the unknown traffic class 508 may represent that the traffic classifier 304 is unable to match the characteristics or behavior of the traffic flow to any of the types of traffic classes associated with the traffic classifier 304 (such as the first traffic class 502, the second traffic class 504, and the third traffic class 506). In some implementations, the unknown traffic class 508 also may be referred to as a background traffic class. In some other examples, the unknown traffic class 508 and a background traffic class may be different traffic classes associated with different behaviors or characteristics.

In some implementations, an ingress rate trigger for a traffic flow associated with the unknown traffic class 508 may indicate that the traffic flow has an ingress rate burst pattern that satisfies a threshold and the selective classification entity 302 may trigger the reclassification 512 accordingly. Additionally, or alternatively, the ingress rate trigger may indicate that the traffic flow associated with the unknown traffic class 508 has a change of ingress rate that moves from outside to inside a respective set of ingress rate bounds of a respective traffic class (such as the first traffic class 502, the second traffic class 504, or the third traffic class 506). In such implementations, the selective classification entity 302 may trigger a low pass filter wait 510-c period to determine if the ingress rate of the traffic flow remains within the respective set of ingress rate bounds. If the ingress rate remains within the respective set of ingress rate bounds after the low pass filter wait 510-c period, the selective classification entity 302 may trigger the reclassification 512 to reclassify the traffic flow accordingly. In some other examples, the ingress rate trigger may indicate that the traffic characteristics and ingress rate of the traffic flow are outside of the bounds of an existing traffic class (such as the first traffic class 502, the second traffic class 504, or the third traffic class 506). In such implementations, the selective classification entity 302 may trigger the low pass filter wait 510-c to determine if the characteristics of the traffic flow move to within the bounds of an existing traffic flow. If the characteristics of traffic flow, such as the ingress rate, do move into the bounds of an existing traffic flow, the selective classification entity 302 may trigger the reclassification 512 to reclassify the traffic flow accordingly. Otherwise, the selective classification entity 302 may refrain from triggering the reclassification 512 and the traffic flow may remain associated with the unknown traffic class 508.

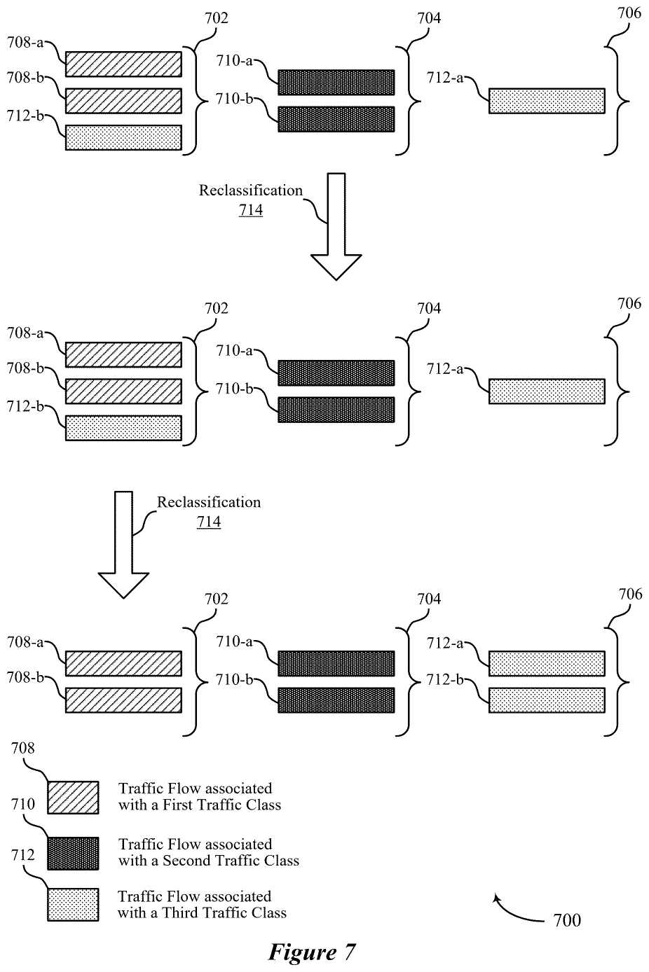

In accordance with the techniques of the present disclosure, the selective classification entity 302 may be capable of triggering the reclassification 512 via the traffic classifier 304 to reclassify traffic flows associated with ingress rate triggers. In some implementations, triggering the reclassification 512 of traffic flows in accordance with ingress rate triggers may be an example of a reclassification 512 that is pre-emptive. In some implementations, the selective classification entity 302 also may be capable of triggering the reclassification 512 in response to an action or event such as a traffic flow failing to satisfy an SLA associated with the traffic flow, a traffic flow queue congestion associated with the traffic flow failing to satisfy the SLA, or both. Further description of the techniques of the present disclosure related to the triggering of the reclassification 512 may be described elsewhere herein, such as with reference to FIGS. 6 and 7.

FIG. 6 shows an example of a traffic flow queue diagram 600 that supports triggered classification of a traffic flow. In some implementations, the traffic flow queue diagram 600 may implement or be implemented by the communication network 100, the communication network 200, the signaling diagram 300, or any combination thereof. For example, the traffic flow queue diagram 600 may illustrate reclassification of traffic flows utilized by an AP 102 or a STA 104, such as an AP 102 or a STA 104 illustrated by and described with reference to FIGS. 1 and 2. The traffic flow queue diagram 600 illustrates a first traffic flow queue 602 and a second traffic flow queue 604, each associated with a respective traffic class, a respective SLA, a respective priority level, or any other type of indicator to group traffic flows together. In some implementations, the traffic flow queue diagram 600 may represent traffic flows being misclassified resulting in the traffic flows failing to satisfy an SLA associated with the traffic flow, traffic flow congestion associated with the failure to satisfy the SLA, or both. The traffic flow queue diagram 600 may illustrate some of the techniques of the present disclosure that can result in a traffic flow being reclassified to ensure an SLA of a traffic flow is satisfied, a traffic flow congestion is reduced, or both, to reduce the latency and improve the reliability of communications via one or more traffic flows in a wireless communication network.

In some implementations, during an initial classification of a traffic flow, the traffic flow may be placed in an incorrect traffic flow queue. The first traffic flow queue 602 may be for one or more traffic flows 606 (such as a traffic flow 606-a and a traffic flow 606-b) associated with a first traffic class and the second traffic flow queue 604 may be for one or more traffic flows 608 (such as a traffic flow 608-a and a traffic flow 608-b) associated with a second traffic class. For example, the first traffic flow queue 602 may represent a gaming flow queue for one or more gaming traffic flows and the second traffic flow queue 604 may represent a background flow queue for one or more background traffic flows.

In some implementations, the first traffic flow queue 602 may be associated with a different priority level than the second traffic flow queue 604. For example, a gaming flow queue may have a higher priority level than a background flow queue and may be a prioritized traffic flow queue. As illustrated in the traffic flow queue diagram 600, the traffic flow 608-b may be misclassified to the first traffic flow queue 602 rather than to the second traffic flow queue 604. For example, the traffic flow 608-b may be a background traffic flow that is classified into the first traffic flow queue 602 that is a gaming queue and is associated with a relatively high priority level.

In some implementations, due to the traffic flow 608-b being in the first traffic flow queue 602, the traffic flow 608-b may cause the first traffic flow queue 602 to fail to satisfy an SLA (such as a throughput or latency SLA) of the first traffic flow queue 602. For example, the first traffic flow queue 602 may be capable of assigning processing resources to a maximum of two traffic flows (such as the traffic flow 606-a and the traffic flow 606-b). Thus, having the traffic flow 608-b be assigned to the first traffic flow queue 602 may cause a traffic flow congestion of the first traffic flow queue 602 due to the quantity of traffic flows assigned to the first traffic flow queue 602, which can result in a degradation in a QoS for an end user. For example, due to a traffic flow congesting in a gaming flow queue, a user may experience an increase in latency within the game.

The selective classification entity 302, as illustrated by and described with reference to FIG. 3, may trigger the traffic classifier 304, as also illustrated by and described with reference to FIG. 3, to perform a reclassification 610 to reclassify each traffic flow in the traffic flow queue that is experiencing a traffic congestion. For example, the traffic classifier 304 may perform reclassification 610 for the traffic flow 606-a, the traffic flow 606-b, and the traffic flow 608-b. In the reclassification 610, the traffic classifier 304 may determine that the traffic flow 606-a and the traffic flow 606-b are in the correct traffic flow queue (the first traffic flow queue 602) and that the traffic flow 608-b is misclassified and is to be in the second traffic flow queue 604. The traffic classifier 304 may reclassify which traffic flow queue the traffic flow 608-b is assigned to, which may result in the traffic flow 608-b being placed into the second traffic flow queue 604. In accordance with the reclassification, the SLA parameters of the first traffic flow queue 602 may be satisfied and the first traffic flow queue 602 may be capable of handling the latency sensitive traffic of the traffic flow 606-a and the traffic flow 606-b. In some implementations, performing the reclassification 610 on the traffic flows of the traffic flow queue associated with an SLA failure of an SLA of a traffic flow, an SLA of a traffic flow queue, or both, may be unable to resolve the SLA failure. For example, the traffic flow misclassification may be in a higher priority queue causing an SLA failure in the lower priority queue. Additional details associated with performing a reclassification 610 multiple times to resolve an SLA failure are described elsewhere herein, including with reference to FIG. 7.

FIG. 7 shows an example of a traffic flow queue diagram 700 that supports triggered classification of a traffic flow. In some implementations, the traffic flow queue diagram 700 may implement or be implemented by the communication network 100, the communication network 200, the signaling diagram 300, or any combination thereof. For example, the traffic flow queue diagram 700 may illustrate reclassification of traffic flows utilized by corresponding devices or components that may be or may be within an AP 102 or a STA 104, such as an AP 102 or a STA 104 illustrated by and described with reference to FIGS. 1 and 2. The traffic flow queue diagram 700 may include a first traffic flow queue 702, a second traffic flow queue 704, and a third traffic flow queue 706, each associated with a respective traffic class, a respective SLA, a respective priority level, or any other type of indicator to group traffic flows together. For example, the first traffic flow queue 702, the second traffic flow queue 704, and the third traffic flow queue 706 may be configured for different types of traffic flows. By way of further example, the first traffic flow queue 702 may include one or more traffic flows 708 (such as a traffic flow 708-a and a traffic flow 708-b) associated with a first traffic class, the second traffic flow queue 704 may include one or more traffic flows 710 (such as a traffic flow 710-a and a traffic flow 710-b) associated with a second traffic class, and the third traffic flow queue 706 may include one or more traffic flows 712 (such as a traffic flow 712-a and a traffic flow 712-b) associated with a third traffic class.

In some implementations, the traffic flow queue diagram 700 may represent traffic flows being misclassified resulting in the traffic flows failing to satisfy an SLA associated with the traffic flow, traffic flow congestion associated with the failure to satisfy the SLA, or both. The traffic flow queue diagram 700 may illustrate some of the techniques of the present disclosure that can result in a traffic flow being reclassified to ensure an SLA of a traffic flow is satisfied, a traffic flow congestion is reduced, or both, Moreover, such reclassification of a traffic flow may reduce the latency and improve the reliability of communications via the one or more traffic flows in a wireless communication network.

In some implementations, an internal QoS breach or SLA failure may be detected in the second traffic flow queue 704. For example, a selective classification entity 302 may obtain an indication of a failure to satisfy an SLA associated with a traffic flow (such as a traffic flow of the one or more traffic flows 708) of an application. Moreover, the failure to satisfy the SLA associated with the traffic flow may be associated with a traffic flow congestion of at least one traffic flow queue of a set of traffic flow queues (such as the first traffic flow queue 702, the second traffic flow queue 704, and the third traffic flow queue 706). For example, the traffic flow 710-a may fail to satisfy an SLA associated with traffic flow 710-a, the second traffic flow queue 704 may fail to satisfy an SLA associated with the second traffic flow queue 704, or both due to a traffic flow congestion in at least one traffic flow queue of the set of traffic flow queues.

In response, the selective classification entity 302, as illustrated by and described with reference to FIG. 3, may trigger the traffic classifier 304, as also illustrated by and described with reference to FIG. 3, to perform a reclassification 714 to attempt to reclassify the traffic flow 710-a and the traffic flow 710-b in the second traffic flow queue 704. In some scenarios, the traffic flow 710-a and the traffic flow 710-b may be correctly classified in the second traffic flow queue 704. In accordance with determining that the classification of the one or more traffic flows 710 of the second traffic flow queue 704 are correctly classified, the traffic classifier 304 may perform a reclassification 714 on the traffic flows of other priority queues. In some implementations, the traffic classifier 304 may move to the next traffic flow queue in accordance with the priority level and attempt to perform the reclassification 714 on the traffic flows of the prioritized traffic flow queue. For example, the first traffic flow queue 702 may represent a gaming flow queue, the second traffic flow queue 704 may represent a voice flow queue, and the third traffic flow queue 706 may represent a background flow queue such that the first traffic flow queue 702 is higher in priority than the second traffic flow queue 704 and the third traffic flow queue 706 and the second traffic flow queue 704 is higher in priority than the third traffic flow queue 706.

The traffic classifier 304 may perform the reclassification 714 on the traffic flows of the first traffic flow queue 702. In accordance with the reclassification 714, the traffic classifier 304 may determine that the traffic flow 708-a and the traffic flow 708-b are correctly classified in the first traffic flow queue 702 and the traffic flow 712-b is misclassified in the first traffic flow queue 702. The reclassification 714 may reclassify the traffic flow 712-b into the third traffic flow queue 706, which may result in freeing up resources at a scheduler. For example, because the traffic flow 712-b may be associated with a third traffic class that is a background traffic class and is associated with relatively low priority level, having the traffic flow 712-b in the first traffic flow queue 702 may result in a relatively large quantity of resource consumption to keep the traffic flow 712-b active. Therefore, reclassifying the traffic flow 712-b into the third traffic flow queue 706 may reduce the resource consumption levels of the first traffic flow queue 702, which may improve the performance of the second traffic flow queue 704 (and the first traffic flow queue 702). For example, because the second traffic flow queue 704 has a lower priority than the first traffic flow queue 702, the performance of the second traffic flow queue 704 may degrade if additional resources are being consumed to support traffic flows in the first traffic flow queue 702. In implementations in which the reclassification 714 (such as a reclassification 714 across all traffic flow queues) is unable to result in a satisfaction of a violated SLA, an admission control entity may adjust the SLA.

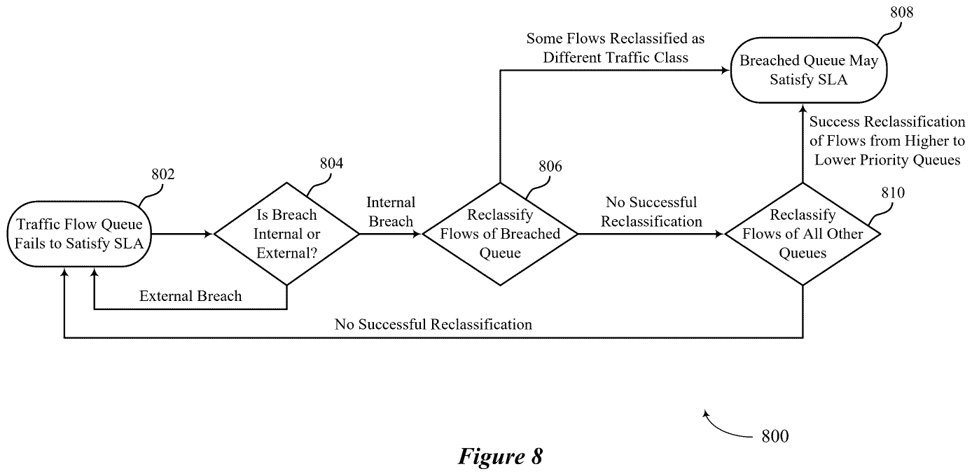

FIG. 8 shows an example of a flowchart 800 that supports triggered classification of a traffic flow. In some implementations, the flowchart 800 may implement or be implemented by the communication network 100, the communication network 200, the signaling diagram 300, the traffic flow queue diagram 600, the traffic flow queue diagram 700, or any combination thereof. For example, the flowchart 800 may illustrate reclassification of traffic flows utilized by corresponding devices that may be or may be within an AP 102 or a STA 104, such as an AP 102 or a STA 104 illustrated by and described with reference to FIGS. 1 and 2. In some implementations, the flowchart 800 may illustrate a procedure for reclassifying traffic flows that are misclassified resulting in the traffic flows failing to satisfy an SLA associated with the traffic flow, traffic flow congestion associated with the failure to satisfy the SLA, or both. The flowchart 800 may illustrate some of the techniques of the present disclosure that can result in a traffic flow being reclassified to ensure an SLA of a traffic flow is satisfied, a traffic flow congestion is reduced, or both. Moreover, such reclassification of a traffic flow may reduce the latency and improve the reliability of communications via the one or more traffic flows in a wireless communication network. In some aspects, the selective classification entity 302 and the traffic classifier 304, as illustrated by and described with reference to FIG. 3, may perform one or more operations of the flowchart 800.

At 802, the selective classification entity 302 may obtain an indication of a traffic flow of an application failing to satisfy an SLA associated with the traffic flow. The traffic flow may be associated with a first traffic class of a set of traffic classes corresponding to the application. Moreover, the first traffic class may be associated with a first traffic flow queue of a set of traffic flow queues. Further, the failure to satisfy the SLA associated with the traffic flow may be associated with a traffic flow congestion of at least one traffic flow queue of the set of traffic flow queues.

At 804, the selective classification entity 302 may determine with a QoS breach associated with the indication of the traffic flow failing to satisfy the SLA is an internal breach or an external breach. In some implementations, if the QoS breach is an external breach, the QoS breach may be associated with (such as caused by) relatively high network noise, a relatively poor signal-to-noise ratio (SNR), or any other type of indicator. Further, if the QoS breach is an external breach, the selective classification entity 302 may communicate with other wireless devices or other components of a wireless device to determine how to minimize the network nose, the SNRs, or both.

At 806, if the QoS breach is an internal breach, the selective classification entity 302 may output, to the traffic classifier 304, an instruction to perform a traffic classification of a set of traffic flows associated with the first traffic flow queue that includes the traffic flow failing to satisfy an SLA. The instruction may be output in accordance with the traffic flow failing to satisfy the SLA of the traffic flow and in accordance with the failure to satisfy the SLA being associated with the traffic flow congestion of the at least one traffic flow queue. The traffic classifier 304 may perform the traffic classification of the set of traffic flows associated with the first traffic flow queue in accordance with the instruction from the selective classification entity 302.

At 808, if the traffic classification of the set of traffic flows in the first traffic flow queue results in one or more traffic flows being reclassified, the first traffic flow queue may satisfy the SLA. For example, if a respective traffic flow in the first traffic flow queue is misclassified, reclassifying the respective traffic flow into the correct traffic flow queue can result in the traffic flow being capable of satisfying the SLA of the traffic flow.

At 810, the selective classification entity 302 may obtain an indication that the traffic classification of the set of traffic flows associated with the first traffic flow failed to result in a satisfaction of the SLA associated with the traffic flow. In response, the selective classification entity 302 may output, to the traffic classifier 304, a second instruction to perform a second traffic classification of a second set of traffic flows associated with a second traffic flow queue of the set of traffic queues, in accordance with the indication. Further, the second traffic flow queue may be (associated with) a prioritized traffic queue associated with a defined SLA that is different from or the same as the SLA of the traffic flow. At 808, if the second traffic classification of the second set of traffic flows associated with the second traffic flow queue is successful in mitigating (such as reducing) the traffic flow congestion, the first traffic flow queue may satisfy the SLA.

Therefore, the techniques of the present disclosure may result in the traffic classifier 304 being capable of reclassifying traffic flows that are misclassified in traffic flow queues to ensure each traffic flow and each traffic queue is capable of satisfying a corresponding SLA.

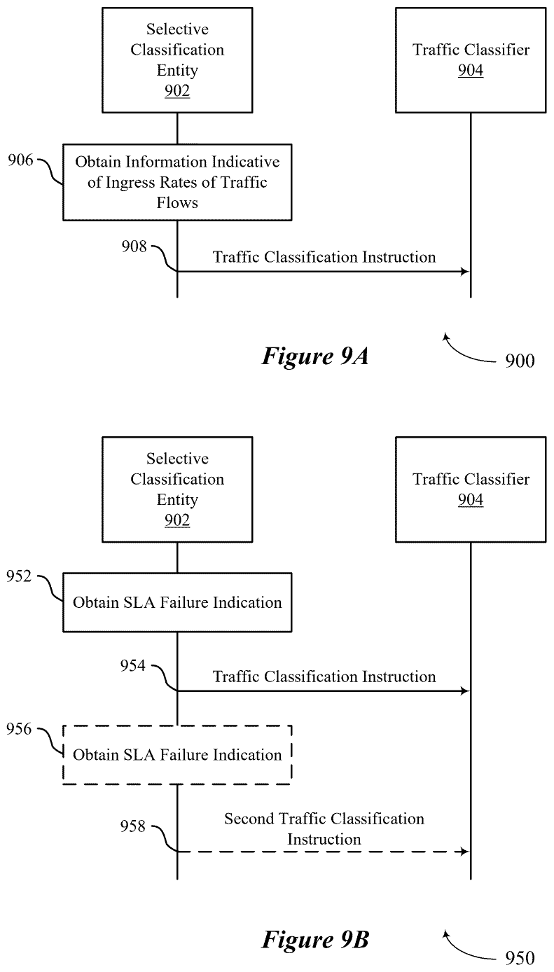

FIG. 9A shows an example of a process flow 900 that supports triggered classification of a traffic flow. In some implementations, the process flow 900 may implement or be implemented by the communication network 100, the communication network 200, the signaling diagram 300, the ingress rate timeline 400, the ingress rate timeline 402, the ingress rate timeline 404, the flowchart 500, or any combination thereof. the traffic flow queue diagram 600, the traffic flow queue diagram 700, the flowchart 800, or any combination thereof. For example, the process flow 900 may include a selective classification entity 902, which may be an example of the selective classification entity 302 of FIG. 3, and a traffic classifier 904, which may be an example of the traffic classifier 304 of FIG. 3.

In the following description of the process flow 900, the operations between the selective classification entity 902 and the traffic classifier 904 may be performed in different orders or at different times. Some operations also may be left out of the process flow 900, or other operations may be added. A though the selective classification entity 902 and the traffic classifier 904 are shown performing the operations of the process flow 900, some aspects of some operations also may be performed by one or more other devices or services, such as a CPE, a server device, an ISP device, a cloud-based platform or service, or any other wired or wireless device. Further, although shown as separate entities, in some implementations, the selective classification entity 902 and the traffic classifier 904 may be associated with (such as within) a same entity or may be collocated (such as within a same device or apparatus). In some other implementations, the selective classification entity 902 and the traffic classifier 904 may be non-collocated (such as distributed across two or more devices or apparatuses).

At 906, the selective classification entity 902 may obtain information indicative of an ingress rate associated with a traffic flow of an application. Further, the traffic flow may be associated with (such as initially classified in) a first traffic class of a set of traffic classes corresponding to the application. In some implementations, the selective classification entity 902 may obtain, via the information indicative of the ingress rate, indication that a change of the ingress rate of the traffic flow satisfies at least one ingress rate threshold. Additionally, or alternatively, the selective classification entity 902 may obtain information indicative of a set of ingress rates associated with a set of traffic flows of the application, each ingress rate of the set of ingress rates being associated with a respective traffic flow of the set of traffic flows, with the set of ingress rates including the ingress rate and the set of traffic flows including the traffic flow.

In some implementations, the set of traffic classes may include a video traffic classification, a voice traffic classification, a game traffic classification, a video stream classification, a live cast classification, one or more classification types associated with an AI/ML model, a background traffic classification, an unknown traffic classification, or any combination thereof. In some implementations, the first traffic class may be associated with the unknown traffic classification and a second traffic class may be associated with the video traffic classification, the voice traffic classification, the game traffic classification, or the background traffic classification. Further, the set of traffic classes may be associated with a set of traffic class groups, with each traffic class group of the set of traffic class groups including a respective set of traffic classes of the set of traffic classes, and with each traffic class group of the set of traffic class groups being associated with a respective ingress rate behavior. In some implementations, the first traffic class may be within a first traffic class group of the set of traffic class groups that is associated with a first ingress rate behavior.

At 908, the selective classification entity 902 may output, to the traffic classifier 904, an instruction to perform a traffic classification of at least the traffic flow. Further, the instruction may be output in accordance with a change of the ingress rate satisfying at least one ingress rate threshold associated with the first traffic class, a second traffic class of the set of traffic classes, or both. The at least one ingress rate threshold may be associated with the first traffic class in a first set of scenarios or conditions and may be associated with a second traffic class (such as any traffic class different than the first traffic class) in a second set of scenarios or conditions. For example, the at least one ingress rate threshold may be associated with the first traffic class in scenarios in which the at least one ingress rate threshold is a threshold ingress rate increase or decrease (such as a threshold raw or magnitude ingress rate increase or decrease). In such scenarios, the traffic flow may be a classified as a target class (such that the first traffic class may be voice, video, or gaming), with the at least one ingress rate threshold defined on a per-target class basis. By way of further example, the at least one ingress rate threshold may be associated with a second traffic class (different than the first traffic class) in scenarios in which the at least one ingress rate threshold is a bounds-based ingress rate pattern, such as an ingress rate pattern defined by an ingress rate upper bound and an ingress rate lower bound. In such scenarios, the traffic flow may be initially classified as a non-target class (such that the first traffic class is background), with flows of the non-target class potentially having highly variable ingress rate patterns. Each target class (such as voice, video, or gaming) may be associated with a respective bounds-based ingress rate pattern (such that a traffic classification is instructed in accordance with the ingress rate of the traffic flow satisfying a bounds-based ingress rate pattern of another traffic class different than the first traffic class). Additionally, the instruction may be output in accordance with the change of the ingress rate satisfying the at least one ingress rate threshold for at least a threshold duration. Moreover, the threshold duration may be associated with at least one of the change of the ingress rate or the first traffic class. In some implementations, the traffic classification may be associated with an AI/ML model and the instruction to perform the traffic classification may be output to the AI/ML model.

In some implementations, the threshold duration may be associated with a direction of the change of the ingress rate, a magnitude of the change of the ingress rate, a configuration of the selective classification entity 902 or the traffic classifier 904, or any combination thereof. For example, the threshold duration may be a first quantity of time domain units in accordance with the direction of the change of the ingress rate being an ingress rate decrease. By way of further example, the threshold duration may be a second quantity of time domain units in accordance with the direction of the change of the ingress rate being an ingress rate increase. Further, the second quantity of time domain units may be less than the first quantity of time domain units. Additionally, or alternatively, the threshold duration may be zero seconds in accordance with the direction of the change of the ingress rate being an ingress rate increase and the magnitude of the change of the ingress rate satisfying a threshold magnitude. Further, the threshold duration may be associated with the first traffic class of the first traffic class group.

In some implementations, the at least one ingress rate threshold may be associated with an ingress rate range defined by an ingress rate lower bound and an ingress rate upper bound. In such implementations, the at least one ingress rate threshold may be satisfied in accordance with the change in the ingress rate resulting in the ingress rate being within the ingress rate range for at least the threshold duration. Additionally, or alternatively, the at least one ingress rate threshold may be associated with a threshold (raw or magnitude) increase of the ingress rate, a threshold decrease of the ingress rate, a threshold duration since a previous increase or decrease of the ingress rate, or any combination thereof. Additionally, or alternatively, the at least one ingress rate threshold may be associated with an ingress rate increase over time, an ingress rate decrease over time, a total time between an ingress rate increase and an ingress rate decrease (such as durations between ingress rate increases and ingress rate decreases), or any combination thereof. For example, the at least one ingress rate threshold may be associated with an ingress rate behavior or pattern, with the at least one ingress rate threshold satisfied in accordance with the change in the ingress rate matching or being relatively similar to the ingress rate behavior or pattern.

In some implementations, the selective classification entity 902 may obtain a confidence score associated with the first traffic class associated with the traffic flow, Further, the selective classification entity 902 may output the instruction to perform the traffic classification in accordance with both the change of the ingress rate satisfying the at least one ingress rate threshold and the confidence score satisfying a confidence score threshold. In some implementations, the selective classification entity 902 may output the instruction to perform the traffic classification is in accordance with the indication of the change of the ingress rate satisfying the at least one ingress rate threshold. In some other implementations, the selective classification entity 902 may output the traffic classification instruction in accordance with a satisfaction of an ingress rate behavior. In some implementations, the selective classification entity 902 may output the instruction to perform the traffic classification in accordance with the change of the ingress rate further satisfying a second ingress rate behavior associated with a second traffic class group of the set of traffic class groups.

In some implementations, the selective classification entity may refrain from requesting a reclassification of a traffic flow multiple times (at least consecutively or within a threshold time period). For example, if a traffic flow is again classified into a same traffic class after an instruction by the selective classification entity to perform a traffic reclassification, the selective classification entity may assume that the traffic classifier has additional information that warrants or justifies the original traffic classification. In other words, the selective classification entity may defer to the traffic classifier after a traffic classification instruction.

FIG. 9B shows an example of a process flow 950 that supports triggered classification of a traffic flow. In some implementations, the process flow 950 may implement or be implemented by the communication network 100, the communication network 200, the signaling diagram 300, the traffic flow queue diagram 600, the traffic flow queue diagram 700, the flowchart 800, or any combination thereof. For example, the process flow 900 may include a selective classification entity 902, which may be an example of the selective classification entity 302 of FIG. 3, and a traffic classifier 904, which may be an example of the traffic classifier 304 of FIG. 3.

In the following description of the process flow 950, the operations between the selective classification entity 902 and the traffic classifier 904 may be performed in different orders or at different times. Some operations also may be left out of the process flow 950, or other operations may be added. A though the selective classification entity 902 and the traffic classifier 904 are shown performing the operations of the process flow 950, some aspects of some operations also may be performed by one or more other devices or services, such as a CPE, a server device, an ISP device, a cloud-based platform or service, or any other wired or wireless device. Further, although shown as separate entities, in some implementations, the selective classification entity 902 and the traffic classifier 904 may be associated with (such as within) a same entity or may be collocated (such as within a same device or apparatus). In some other implementations, the selective classification entity 902 and the traffic classifier 904 may be non-collocated (such as distributed across two or more devices or apparatuses).

At 952, the selective classification entity 902 may obtain an indication of a failure to satisfy an SLA associated with a traffic flow of an application. The traffic flow may be associated with a first traffic class of a set of traffic classes corresponding to the application. Further, the first traffic class may be associated with a first traffic flow queue of a set of traffic flow queues, and the failure to satisfy the SLA may be associated with a traffic flow congestion of at least one traffic flow queue of the set of traffic flow queues. In some implementations, the failure to satisfy the SLA may be associated with a failure to satisfy a throughput threshold associated with the SLA, a latency threshold associated with the SLA, or both. Additionally, or alternatively, the SLA may be further associated with a first traffic flow queue.

At 954, the selective classification entity 902 may output, to the traffic classifier 904, an instruction to perform a traffic classification of a set of traffic flows associated with the first traffic flow queue. The selective classification entity 902 may output the instruction in accordance with the failure to satisfy the SLA associated with the traffic flow, and the failure to satisfy the SLA being associated with the traffic flow congestion of the at least one traffic flow queue. In some implementations, the selective classification entity 902 outputting the instruction in accordance with the failure to satisfy the SLA may be independent from network noise, an SNR, or both. Further, the traffic classification may be associated with an AI/ML model and the selective classification entity 902 may output the instruction to perform the traffic classification to the AI/ML model.

In some implementations, at 956, the selective classification entity 902 may obtain an indication that the traffic classification of the set of traffic flows associated with the first traffic flow queue fails to result in a satisfaction of the SLA associated with the traffic flow. In some implementations, the selective classification entity 902 may obtain the indication from the traffic classifier 904. In response, at 958, the selective classification entity 902 may output, to the traffic classifier 904, a second instruction to perform a second traffic classification of a second set of traffic flows associated with a second traffic flow queue of the set of traffic flow queues. In other words, the selective classification entity 902 may output the second instruction in accordance with the indication that the traffic classification of the set of traffic flows associated with the first traffic flow queue failed to result in the satisfaction of the SLA. In some implementations, the second traffic flow queue may be associated with a prioritized traffic flow queue (relative to the first traffic flow queue) associated with a defined SLA.

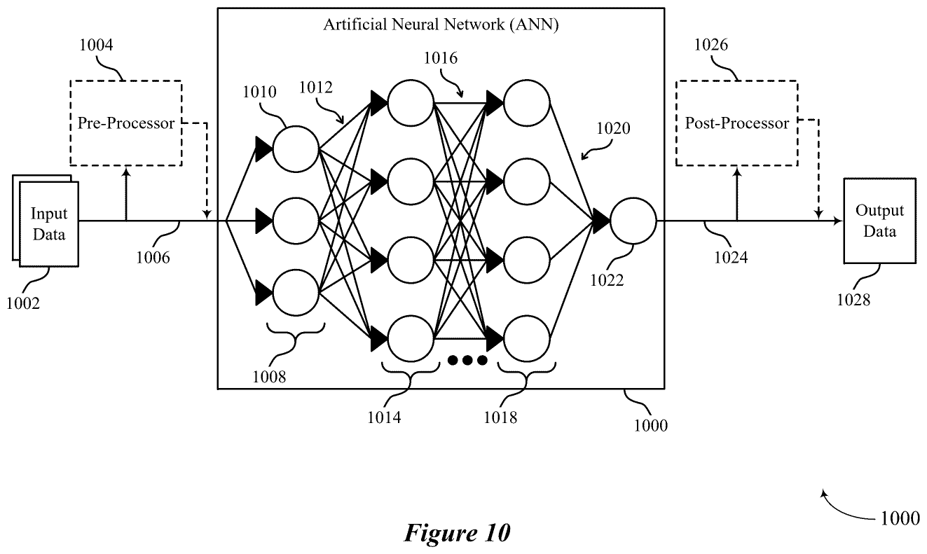

FIG. 10 shows an example block diagram of an example ML model represented by an ANN 1000 that supports triggered classification of a traffic flow. The ANN 1000 may receive input data 1006 which may include one or more bits of data 1002, pre-processed data output from a pre-processor 1004, or some combination thereof. Here, data 1002 may include training data, verification data, application-related data, or the like, according to, for example, the stage of deployment of the ANN 1000. The pre-processor 1004 may be included within the ANN 1000 in some other implementations. The pre-processor 1004 may, for example, process all or a portion of the data 1002 which may result in some of the data 1002 being changed, replaced, deleted, or otherwise modified. In some implementations, the pre-processor 1004 may add additional data to the data 1002. In some implementations, the pre-processor 1004 may be an example of an ML model, such as another ANN. In some implementations, such as a service or platform, among other information sources, may collect the data 1002 for training the ANN 1000, running the ANN 1000, or both.

The ANN 1000 may include at least one first layer 1008 of artificial neurons 1010 to process input data 1006 and provide resulting first layer data via connections or “edges” such as edges 1012 to at least a portion of at least one second layer 1014. The second layer 1014 may process data received via the edges 1012 and may provide second layer output data via edges 1016 to at least a portion of at least one third layer 1018. The third layer 1018 may process data received via the edges 1016 and may provide third layer output data via edges 1020 to at least a portion of a final layer 1022 including one or more artificial neurons 1010 to provide output data 1024. In some implementations, all or part of the output data 1024 may be further processed in some manner by a post-processor 1026. The ANN 1000 may provide output data 1028 that is in accordance with the output data 1024, post-processed data output from the post-processor 1026, or some combination thereof.

The post-processor 1026 may be included within the ANN 1000 in some other implementations. The post-processor 1026 may, for example, process all or a portion of the output data 1024 which may result in the output data 1028 being different, at least in part, to the output data 1024, as result of data being changed, replaced, deleted, or otherwise modified. In some implementations, the post-processor 1026 may be configured to add additional data to the output data 1024. The second layer 1014 and the third layer 1018 may represent intermediate or hidden layers that may be arranged in a hierarchical or other like structure. Although not explicitly shown, there may be one or more further intermediate layers between the second layer 1014 and the third layer 1018. In some implementations, the post-processor 1026 may be an ML model, such as another ANN.

The structure and training of artificial neurons 1010 in the various layers may be tailored to specific rules or conditions of an application. Within a given layer such as the first layer 1008, the second layer 1014, or the third layer 1018 of the ANN 1000, some or all of the artificial neurons 1010 may be configured to process information provided to the layer and output corresponding transformed information from the layer. For example, transformed information from a layer may represent a weighted sum of the input information associated with or otherwise in accordance with a non-linear activation function or other activation function used to “activate” artificial neurons of a next layer. Artificial neurons in such a layer may be activated by or be responsive to parameters such as the previously described weights and biases of the ANN 1000. The weights and biases of the ANN 1000 may be adjusted during a training process or during operation of the ANN 1000. The weights of the various artificial neurons 1010 may control a strength of connections between layers or artificial neurons 1010, while the biases may control a direction of connections between the layers or artificial neurons 1010. An activation function may select (such as determine or otherwise ascertain) whether an artificial neuron 1010 transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1006. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 1000, may be conducted using training data. Training data may include one or more datasets which the ANN 1000 may use to identify patterns or relationships. Training data may represent various types of information, including written, visual, audio, environmental context, operational properties, or other data. During training, the parameters (such as the weights and biases) of the artificial neurons 1010 may be changed, such as to minimize or otherwise reduce a loss function or a cost function. A training process may be repeated multiple times to fine-tune the ANN 1000 with each iteration. In some implementations, the training process may include training the ANN 1000 to classify traffic flows to be associated with traffic classes. For example, the training data may include various traffic characteristic or behavior information and the corresponding type of traffic class.

The ANN 1000 or other ML models may be implemented in various types of processing circuits along with memory and applicable instructions therein. For example, general-purpose hardware circuits, such as one or more CPUs, one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like also may be employed. In some implementations, the ML model may be implemented by an NPU or a TPU embedded in a system-on-a-chip (SoC) along with other components, such as one or more CPUs, GPUs, or the like. An SoC may include several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs also may receive the inferences and be configured to perform certain actions according to the inferences produced by the ML model. The actions performed by the one or more CPUs may include sending commands to other components of the SoC or components external to the SoC to perform certain actions. For example, the CPU may send commands to a transceiver in accordance with the outputs or inferences obtained from an ML model to cause the transceiver to operate on a wireless network in accordance with the ML model.

In some implementations, one or more devices or services may support processes relating to an ML model's usage, maintenance, activation, reporting, or the like. In some implementations, all or part of a dataset or model may be shared across multiple devices, to provide or otherwise augment or improve processing. In some implementations, signaling mechanisms may be utilized at various nodes of a wireless network to signal the capabilities for performing specific functions related to the ML model, support for specific ML models, capabilities for gathering, creating, transmitting training data, or other ML related capabilities. ML models in wireless communications systems may, for example, be employed to support decisions or improve performance relating to wireless resource allocation or selection, wireless channel condition estimation, interference mitigation, beam management, positioning accuracy, energy savings, modulation or coding schemes, or any combination of these or other network parameters. In some implementations, model deployment may occur jointly or separately at various network levels, such as, an AP 102, a STA 104, or a combination thereof.

In some implementations, a traffic classifier may utilize the ANN 1000 to classify traffic flows in response to traffic classification instructions from a selective classification entity. For example, in response to an indication of an ingress rate of a traffic flow or an indication of a traffic flow failing to satisfy an SLA of the traffic flow, the selective classification entity may trigger the ANN 1000 to reclassify the traffic flow. In some implementations, utilizing the techniques of the present disclosure, the quantity of data in the input data 1002 may be relatively less for reclassification of traffic flows. For example, the input data may include the indication of an ingress rate of a traffic flow or the indication of a traffic flow failing to satisfy an SLA of the traffic flow obtained by the selective classification entity. Thus, in accordance with the ANN 1000 being trained to classify and reclassify traffic flows, the output data 1028 may indicate a reclassification of the traffic flow associated with the indication of an ingress rate of a traffic flow, the indication of a traffic flow failing to satisfy an SLA of the traffic flow, or both. For example, in accordance with the indication of the ingress rate being indicative of a change of the ingress rate satisfying an ingress rate threshold for a threshold duration, the ANN 1000 may reclassify a traffic flow accordingly. Further, in accordance with the indication of a traffic flow failing to satisfy an SLA of the traffic flow, the ANN 1000 may attempt to reclassify each traffic flow in a traffic flow queue which can result in reclassifying a misclassified traffic flow thus enabling the traffic flow to satisfy the SLA of the traffic flow.

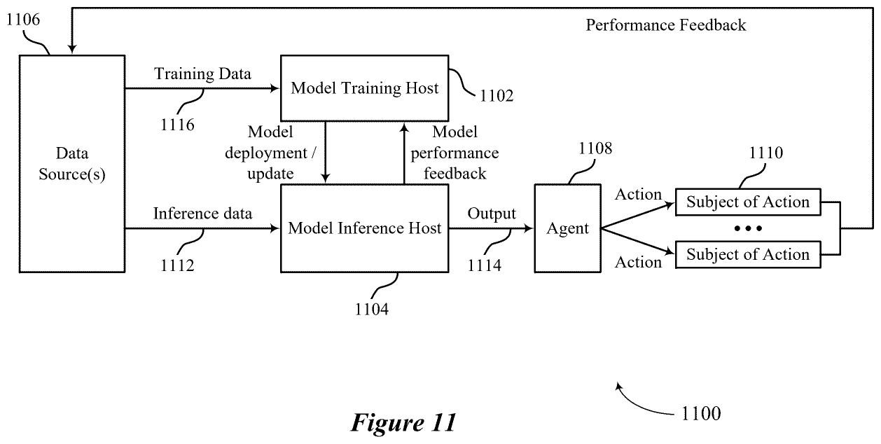

FIG. 11 shows an example block diagram of an example of an ML architecture 1100 that supports triggered classification of a traffic flow. As illustrated, the ML architecture 1100 may include multiple logical entities, such as a model training host 1102, a model inference host 1104, one or more data sources 1106, and an agent 1108. The model inference host 1104 is configured to run an ML model in accordance with inference data 1112 provided by the one or more data sources 1106. The model inference host 1104 may produce output 1114, which may include a prediction or inference, such as a discrete or continuous value in accordance with the inference data 1112, which may be provided as an input to the agent 1108.

The agent 1108 may represent an element or an entity of a communications system including, for example, a RAN, a wired or wireless LAN, a D2D communications system, or any other system. As an example, the agent 1108 may be an AP 102, a STA 104, a CPE, a server device, an ISP device, a cloud-based platform or service, or any other wired or wireless device or entity described with reference to FIGS. 1-10. Additionally, or alternatively, the agent 1108 also may be a type of agent that depends on the type of tasks performed by the model inference host 1104, the type of inference data 1112 provided to the model inference host 1104, or the type of output 1114 produced by the model inference host 1104. In some implementations, the agent 1108 also may be an example of a selective classification entity, a traffic classifier, or a combination thereof, as described with reference to FIG. 2

The agent 1108 may perform one or more actions associated with receiving the output 1114 from the model inference host 1104. For example, if the agent 1108 is, or represents, a selective classification entity, a traffic classifier, or both, and the output from the model inference host 1104 is a classification or a reclassification of a traffic flow, the agent 1108 may determine to classify or reclassify the traffic class of a traffic flow according to the output 1114. The agent 1108 may indicate the one or more actions performed to at least one subject of an action 1110. For example, if the agent 1108 determines to reclassify a traffic flow, the agent 1108 may send a reclassification indication to the subject of the action 1110 (such as a device or application associated with a traffic flow that is being reclassified). In some implementations, the agent 1108 and the subject of the action 1110 may be the same entity.

Data can be collected from data sources 1106 and may be used as training data 1116 for training an ML model or as inference data 1112 for feeding an ML model inference operation. The data sources 1106 may collect data from various subject of the actions 1110 (such as traffic flow of an application) or other entities (such as APs 102 or STAs 104 operating within a wireless network) and may provide the collected data to a model training host 1102 for ML model training. In some implementations, a selective classification entity may collect the data from multiple traffic flows determine or obtain indications of whether one or more traffic flows are to be reclassified. For example, the selective classification entity may collect the data and obtain, in accordance with analysis of the data, an indication of an ingress rate of a traffic flow, an indication that a traffic flow fails to satisfy an SLA of the traffic flow, or both. In some implementations, if the output 1114 provided to the agent 1108 is inaccurate (or the accuracy is below an accuracy threshold), the model training host 1102 may provide feedback to the model inference host 1104 to modify or retrain the ML model used by the model inference host 1104, such as via an ML model deployment update.

The model training host 1102 may be deployed at the same or a different entity than that in which the model inference host 1104 is deployed. For example, to offload model training processing, which can impact the performance of the model inference host 1104, the model training host 1102 may be deployed at a model server or other processing device or system.

In some implementations, an ML model is deployed at or on a device supporting a service or platform for data management and analytics. For example, a selective classification entity may train and trigger a traffic classifier to run or rerun the ML model. The ML model may return with outputs indicative of a reclassification for one or more traffic flows in response to instructions from the selective classification entity to perform a traffic classification for the one or more traffic flows.

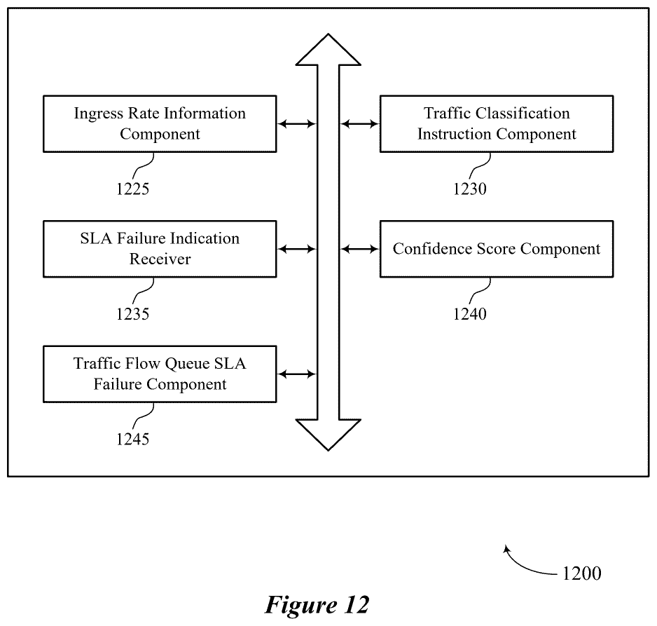

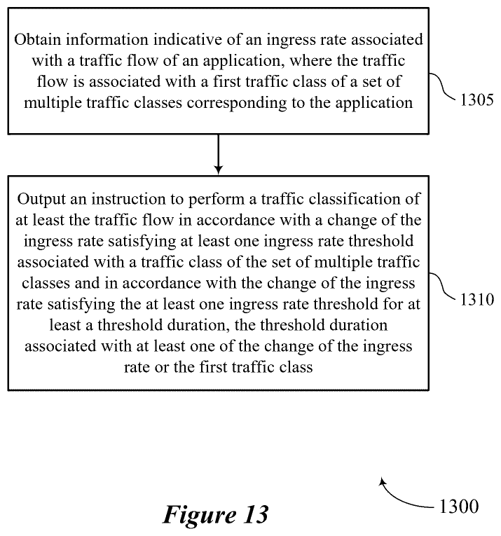

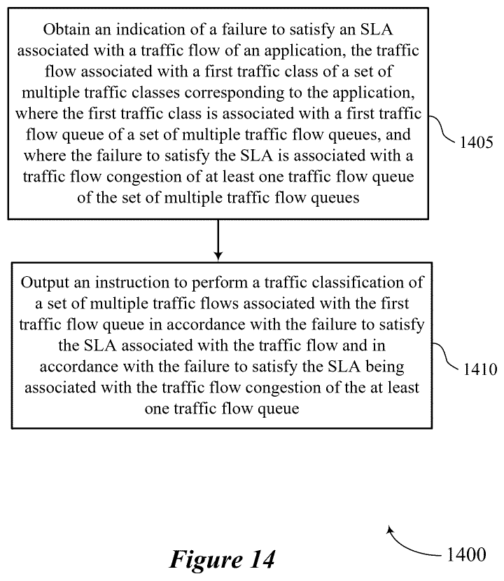

FIG. 12 shows a block diagram of an example device 1200 that supports triggered classification of a traffic flow. In some implementations, the device 1200 is configured to perform the process 1300 and the process 1400 described with reference to FIGS. 13 and 14, respectively. The device 1200 may include one or more chips, SoCs, chipsets, packages, components or devices that individually or collectively constitute or include a processing system. The processing system may interface with other components of the device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1200 may transmit the information output from the chip. In such an example, the second interface may refer to an interface between the processing system of the chip and a reception component, such that the device 1200 may receive information that is passed to the processing system. In some such examples, the first interface also may obtain information, such as from the transmission component, and the second interface also may output information, such as to the reception component.

The processing system of the device 1200 includes processor (or “processing”) circuitry in the form of one or multiple processors, microprocessors, processing units (such as CPUs, GPUs, NPUs (also referred to as neural network processors or deep learning processors (DLPs)), or digital signal processors (DSPs)), processing blocks, ASIC, programmable logic devices (PLDs) (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the device 1200 can be configurable or configured for use in an AP or STA, such as the AP 102 or the STA 104 described with reference to FIG. 1, a CPE, a server device, an ISP device, a cloud-based platform or service, or any other wired or wireless device. In some other implementations, the device 1200 can bean AP, a STA, a CPE, a server device, an ISP device (such as a device used by an ISP to provide or support service to one or more client devices), a cloud-based platform or service, or any other wired or wireless device that includes such a processing system and other components including multiple antennas. The device 1200 is capable of transmitting and receiving wireless or wired communications in the form of, for example, packets. For example, the device 1200 can be configurable or configured to transmit and receive packets in the form of physical layer PPDUs and MPDUs conforming to one or more of the IEEE 802.11 family of wireless communication protocol standards. In some other examples, the device 1200 can be configurable or configured to transmit and receive signals and communications conforming to one or more 3GPP specifications including those for 5G NR or 6G. In some implementations, the device 1200 may include or be coupled with one or more application processors, which may be further coupled with one or more other memories. In some implementations, the device 1200 further includes a user interface (UI) (such as a touchscreen or keypad) and a display, which may be integrated with the UI to form a touchscreen display that is coupled with the processing system. In some implementations, the device 1200 may further include one or more sensors such as, for example, one or more inertial sensors, accelerometers, temperature sensors, pressure sensors, or altitude sensors, that are coupled with the processing system. In some implementations, the device 1200 further includes at least one external network interface coupled with the processing system that enables communication with a core network or backhaul network that enables the device 1200 to gain access to external networks including the Internet.

The device 1200 includes an ingress rate information component 1225, a traffic classification instruction component 1230, an SLA failure indication receiver 1235, a confidence score component 1240, and a traffic flow queue SLA failure component 1245. Portions of one or more of the ingress rate information component 1225, the traffic classification instruction component 1230, the SLA failure indication receiver 1235, the confidence score component 1240, and the traffic flow queue SLA failure component 1245 may be implemented at least in part in hardware or firmware. For example, one or more of the ingress rate information component 1225, the traffic classification instruction component 1230, the SLA failure indication receiver 1235, the confidence score component 1240, and the traffic flow queue SLA failure component 1245 may be implemented at least in part by at least a processor or a modem. In some implementations, portions of one or more of the ingress rate information component 1225, the traffic classification instruction component 1230, the SLA failure indication receiver 1235, the confidence score component 1240, and the traffic flow queue SLA failure component 1245 may be implemented at least in part by a processor and software in the form of processor-executable code stored in memory.

The device 1200 may support classifying traffic of wireless communications in accordance with examples as disclosed herein. The ingress rate information component 1225 is configurable or configured to obtain information indicative of an ingress rate associated with a traffic flow of an application, where the traffic flow is associated with a first traffic class of a set of multiple traffic classes corresponding to the application. The traffic classification instruction component 1230 is configurable or configured to output an instruction to perform a traffic classification of at least the traffic flow in accordance with a triggering criterion being met, such as the ingress rate satisfying a threshold or behavior associated with (such as indicative or representative of) another traffic class different than the first traffic class. In some implementations, the traffic classification instruction component 1230 is configurable or configured to output the instruction to perform the traffic classification in accordance with a change of the ingress rate satisfying at least one ingress rate threshold associated with a traffic class of the set of multiple traffic classes. The traffic class with which the at least one ingress rate threshold is associated may be the first traffic class or a second traffic class other than the first traffic class. The traffic class may be the first traffic class in accordance with the at least one ingress rate threshold being a threshold (raw or magnitude) ingress rate increase or decrease. The traffic class may be the second traffic class in accordance with the at least one ingress rate threshold being an ingress rate range defined by an ingress rate upper bound and an ingress rate lower bound. Additionally, or alternatively, the traffic classification instruction component 1230 is configurable or configured to output the instruction to perform the traffic classification in accordance with the change of the ingress rate satisfying the at least one ingress rate threshold for at least a threshold duration, the threshold duration associated with at least one of the change of the ingress rate or the first traffic class.

In some implementations, to support obtaining the information indicative of the ingress rate, the ingress rate information component 1225 is configurable or configured to obtain an indication that the change of the ingress rate of the traffic flow satisfies the at least one ingress rate threshold, where outputting the instruction to perform the traffic classification is in accordance with the indication.

In some implementations, the threshold duration is associated with a direction of the change of the ingress rate, a magnitude of the change of the ingress rate, or both.

In some implementations, the threshold duration is a first quantity of time domain units in accordance with the direction of the change of the ingress rate being an ingress rate decrease. In some implementations, the threshold duration is a second quantity of time domain units in accordance with the direction of the change of the ingress rate being an ingress rate increase, the second quantity of time domain units being less than the first quantity of time domain units.

In some implementations, the threshold duration is zero seconds in accordance with the direction of the change of the ingress rate being an ingress rate increase and the magnitude of the change of the ingress rate satisfying a threshold magnitude.

In some implementations, the confidence score component 1240 is configurable or configured to obtain a confidence score associated with the first traffic class associated with the traffic flow, where the instruction to perform the traffic classification is output in accordance with both the change of the ingress rate satisfying the at least one ingress rate threshold and the confidence score satisfying a confidence score threshold.

In some implementations, the at least one ingress rate threshold is associated with an ingress rate range defined by an ingress rate lower bound and an ingress rate upper bound. In some implementations, the at least one ingress rate threshold is satisfied in accordance with the change in the ingress rate resulting in the ingress rate being within the ingress rate range for at least the threshold duration.

In some implementations, the at least one ingress rate threshold is associated with a threshold increase of the ingress rate, a threshold decrease of the ingress rate, a threshold duration since a previous increase or decrease of the ingress rate, or any combination thereof.

In some implementations, the at least one ingress rate threshold is associated with an ingress rate increase over time, an ingress rate decrease over time, a total time between an ingress rate increase and an ingress rate decrease, or any combination thereof.

In some implementations, to support obtaining the information indicative of the ingress rate, the ingress rate information component 1225 is configurable or configured to obtain information indicative of a set of multiple ingress rates associated with a set of multiple traffic flows of the application, each ingress rate of the set of multiple ingress rates being associated with a respective traffic flow of the set of multiple traffic flows, where the set of multiple ingress rates includes the ingress rate and the set of multiple traffic flows includes the traffic flow.

In some implementations, the set of multiple traffic classes includes a video traffic classification, a voice traffic classification, a game traffic classification, a video stream classification, a live cast classification, one or more classification types associated with an AI/ML model, a background traffic classification, an unknown traffic classification, or any combination thereof.

In some implementations, the first traffic class is associated with the unknown traffic classification. In some implementations, the traffic class with which the at least one ingress rate threshold is associated (which may be a second traffic class other than the first traffic class) is associated with the video traffic classification, the voice traffic classification, the game traffic classification, or the background traffic classification.

In some implementations, the set of multiple of traffic classes are associated with a set of multiple of traffic class groups. Each traffic class group of the set of multiple of traffic class groups may include a respective set of traffic classes of the set of multiple of traffic classes. Each traffic class group of the set of multiple of traffic class groups may be associated with a respective ingress rate behavior. A traffic classification instruction may be output in accordance with a satisfaction of an ingress rate behavior.

In some implementations, the first traffic class is within a first traffic class group of the set of multiple of traffic class groups that is associated with a first ingress rate behavior. In such implementations, the instruction to perform the traffic classification is output in accordance with the change of the ingress rate further satisfying a second ingress rate behavior associated with a second traffic class group of the set of multiple of traffic class groups.

In some implementations, the threshold duration is associated with the first traffic class.

In some implementations, the traffic classification is associated with an AI/ML model and the instruction to perform the traffic classification is output to the AI/ML model.

Additionally, or alternatively, the device 1200 may support classifying traffic of wireless communications in accordance with examples as disclosed herein. The SLA failure indication receiver 1235 is configurable or configured to obtain an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues. In some implementations, the traffic classification instruction component 1230 is configurable or configured to output an instruction to perform a traffic classification of a set of multiple traffic flows associated with the first traffic flow queue in accordance with a triggering criterion being met. For example, the traffic classification instruction component 1230 is configurable or configured to output the instruction to perform the traffic classification in accordance with the failure to satisfy the SLA associated with the traffic flow. Additionally, or alternatively, the traffic classification instruction component 1230 is configurable or configured to output the instruction to perform the traffic classification in accordance with the failure to satisfy the SLA being associated with the traffic flow congestion of the at least one traffic flow queue.

In some implementations, the traffic flow queue SLA failure component 1245 is configurable or configured to obtain an indication that the traffic classification of the set of multiple traffic flows associated with the first traffic flow queue fails to result in a satisfaction of the SLA associated with the traffic flow. In some implementations, the traffic classification instruction component 1230 is configurable or configured to output a second instruction to perform a second traffic classification of a second set of multiple traffic flows associated with a second traffic flow queue, of the set of multiple traffic flow queues, in accordance with the indication that the traffic classification of the set of multiple traffic flows associated with the first traffic flow queue failed to result in the satisfaction of the SLA, where the second traffic flow queue is associated with a prioritized traffic flow queue associated with a defined SLA.

In some implementations, outputting the instruction is in accordance with the failure to satisfy the SLA being independent from network noise, an SNR, or both.

In some implementations, the failure to satisfy the SLA is associated with a failure to satisfy a throughput threshold associated with the SLA, a latency threshold associated with the SLA, or both.

In some implementations, the SLA is further associated with the first traffic flow queue.

In some implementations, the traffic classification is associated with an AI/ML model and the instruction to perform the traffic classification is output to the AI/ML model.

FIG. 13 shows a flowchart illustrating an example process 1300 performable by or at an apparatus (such as a selective classification entity) that supports triggered classification of a traffic flow. The operations of the process 1300 may be implemented by an apparatus or its components as described herein. For example, the process 1300 may be performed by a device, such as the device 1200 described with reference to FIG. 12, operating as or within a wireless AP, a wireless STA, a CPE, a server device, an ISP device, a cloud-based platform or service, or any other wired or wireless device. In some implementations, the process 1300 may be performed by a wireless AP or a wireless STA, such as one of the APs 102 or the STAs 104 described with reference to FIG. 1.

In some implementations, in 1305, the apparatus may obtain information indicative of an ingress rate associated with a traffic flow of an application, where the traffic flow is associated with a first traffic class of a set of multiple traffic classes corresponding to the application. In some implementations, aspects of the operations of 1305 may be performed by an ingress rate information component 1225 as described with reference to FIG. 12.

In some implementations, in 1310, the apparatus may output an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class. In some implementations, aspects of the operations of 1310 may be performed by a traffic classification instruction component 1230 as described with reference to FIG. 12.

FIG. 34 shows a flowchart illustrating an example process 1400 performable by or at an apparatus (such as a selective classification entity) that supports triggered classification of a traffic flow. The operations of the process 1400 may be implemented by an apparatus or its components as described herein. For example, the process 1400 may be performed by a device, such as the device 1200 described with reference to FIG. 12, operating as or within a wireless AP, a wireless STA, a CPE, a server device, an ISP device, a cloud-based platform or service, or any other wired or wireless device. In some implementations, the process 1400 may be performed by a wireless AP or a wireless STA, such as one of the APs 102 or the STAs 104 described with reference to FIG. 1.

In some implementations, in 1405, the apparatus may obtain an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues. In some implementations, aspects of the operations of 1405 may be performed by an SLA failure indication receiver 1235 as described with reference to FIG. 12.

In some implementations, in 1410, the apparatus may output an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue. In some implementations, aspects of the operations of 1410 may be performed by a traffic classification instruction component 1230 as described with reference to FIG. 12.

Implementation examples are described in the following numbered clauses:

Clause 1: A method for traffic classification, including: obtaining information indicative of an ingress rate associated with a traffic flow of an application, where the traffic flow is associated with a first traffic class of a set of multiple traffic classes corresponding to the application; and outputting an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Clause 2: The method of clause 1, where obtaining the information indicative of the ingress rate includes: obtaining an indication that the change of the ingress rate of the traffic flow satisfies the at least one ingress rate threshold, where outputting the instruction to perform the traffic classification is in accordance with the indication.

Clause 3: The method of any of clauses 1-2, where the threshold duration is associated with a direction of the change of the ingress rate, a magnitude of the change of the ingress rate, or both.

Clause 4: The method of clause 3, where the threshold duration is a first quantity of time domain units in accordance with the direction of the change of the ingress rate being an ingress rate decrease; and the threshold duration is a second quantity of time domain units in accordance with the direction of the change of the ingress rate being an ingress rate increase, the second quantity of time domain units being less than the first quantity of time domain units.

Clause 5: The method of any of clauses 3-4, where the threshold duration is zero seconds in accordance with the direction of the change of the ingress rate being an ingress rate increase and the magnitude of the change of the ingress rate satisfying a threshold magnitude.

Clause 6: The method of any of clauses 1-5, where the threshold duration is associated with the first traffic class.

Clause 7: The method of any of clauses 1-6, further including: obtaining a confidence score associated with the first traffic class associated with the traffic flow, where the instruction to perform the traffic classification is output in accordance with both the change of the ingress rate satisfying the at least one ingress rate threshold and the confidence score satisfying a confidence score threshold.

Clause 8: The method of any of clauses 1-7, where the at least one ingress rate threshold is associated with an ingress rate range defined by an ingress rate lower bound and an ingress rate upper bound, and the at least one ingress rate threshold is satisfied in accordance with the change in the ingress rate resulting in the ingress rate being within the ingress rate range for at least the threshold duration.

Clause 9: The method of any of clauses 1-8, where the at least one ingress rate threshold is associated with a threshold increase of the ingress rate, a threshold decrease of the ingress rate, a threshold duration since a previous increase or decrease of the ingress rate, or any combination thereof.

Clause 10: The method of any of clauses 1-9, where the at least one ingress rate threshold is associated with an ingress rate increase over time, an ingress rate decrease over time, a total time between an ingress rate increase and an ingress rate decrease, or any combination thereof.

Clause 11: The method of any of clauses 1-10, where obtaining the information indicative of the ingress rate includes: obtaining information indicative of a set of multiple ingress rates associated with a set of multiple traffic flows of the application, each ingress rate of the set of multiple ingress rates being associated with a respective traffic flow of the set of multiple traffic flows, where the set of multiple ingress rates includes the ingress rate and the set of multiple traffic flows includes the traffic flow.

Clause 12: The method of any of clauses 1-11, where the set of multiple traffic classes includes a video traffic classification, a voice traffic classification, a game traffic classification, a video stream classification, a live cast classification, one or more classification types associated with an AI/ML model, a background traffic classification, an unknown traffic classification, or any combination thereof.

Clause 13: The method of clause 12, where the first traffic class is associated with the unknown traffic classification. In some aspects, the traffic class with which the at least one ingress rate threshold is associated (which may be a second traffic class other than the first traffic class) is associated with the video traffic classification, the voice traffic classification, the game traffic classification, or the background traffic classification.

Clause 14: The method of any of clauses 1-13, where the set of multiple traffic classes is associated with a set of multiple traffic class groups, each traffic class group of the set of multiple traffic class groups includes a respective set of traffic classes of the set of multiple traffic classes, each traffic class group of the set of multiple traffic class groups is associated with a respective ingress rate behavior, and a traffic classification instruction is output in accordance with a satisfaction of an ingress rate behavior.

Clause 15: The method of clause 14, where the first traffic class is within a first traffic class group of the set of multiple traffic class groups that is associated with a first ingress rate behavior, and the instruction to perform the traffic classification is output in accordance with the change of the ingress rate further satisfying a second ingress rate behavior associated with a second traffic class group of the set of multiple traffic class groups.

Clause 16: The method of any of clauses 1-15, where the traffic classification is associated with an AI/ML model and the instruction to perform the traffic classification is output to the AI/ML model.

Clause 17: A method for traffic classification, including: obtaining an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues; and outputting an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Clause 18: The method of clause 17, further including: obtaining an indication that the traffic classification of the set of multiple traffic flows associated with the first traffic flow queue fails to result in a satisfaction of the SLA associated with the traffic flow; and outputting a second instruction to perform a second traffic classification of a second set of multiple traffic flows associated with a second traffic flow queue, of the set of multiple traffic flow queues, in accordance with the indication that the traffic classification of the set of multiple traffic flows associated with the first traffic flow queue failed to result in the satisfaction of the SLA, where the second traffic flow queue is associated with a prioritized traffic flow queue associated with a defined SLA.

Clause 19: The method of any of clauses 17-18, where outputting the instruction is in accordance with the failure to satisfy the SLA being independent from network noise, an SNR, or both.

Clause 20: The method of any of clauses 17-19, where the failure to satisfy the SLA is associated with a failure to satisfy a throughput threshold associated with the SLA, a latency threshold associated with the SLA, or both.

Clause 21: The method of any of clauses 17-20, where the SLA is further associated with the first traffic flow queue.

Clause 22: The method of any of clauses 17-21, where the traffic classification is associated with an AI/ML model and the instruction to perform the traffic classification is output to the AI/ML model.

Clause 23: An apparatus, including: a processing system that includes processor circuitry and memory circuitry that stores code, the processing system configured to cause the apparatus to: obtain information indicative of an ingress rate associated with a traffic flow of an application, where the traffic flow is associated with a first traffic class of a set of multiple traffic classes corresponding to the application; and output an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Clause 24: The apparatus of clause 23, where, to obtain the information indicative of the ingress rate, the processing system is configured to cause the apparatus to: obtain an indication that the change of the ingress rate of the traffic flow satisfies the at least one ingress rate threshold, where outputting the instruction to perform the traffic classification is in accordance with the indication.

Clause 25: The apparatus of any of clauses 23-24, where the threshold duration is associated with a direction of the change of the ingress rate, a magnitude of the change of the ingress rate, or both.

Clause 26: The apparatus of clause 25, where the threshold duration is a first quantity of time domain units in accordance with the direction of the change of the ingress rate being an ingress rate decrease; and the threshold duration is a second quantity of time domain units in accordance with the direction of the change of the ingress rate being an ingress rate increase, the second quantity of time domain units being less than the first quantity of time domain units.

Clause 27: The apparatus of any of clauses 25-26, where the threshold duration is zero seconds in accordance with the direction of the change of the ingress rate being an ingress rate increase and the magnitude of the change of the ingress rate satisfying a threshold magnitude.

Clause 28: The apparatus of any of clauses 23-27, where the threshold duration is associated with the first traffic class.

Clause 29: The apparatus of any of clauses 23-28, where the processing system is further configured to cause the apparatus to: obtain a confidence score associated with the first traffic class associated with the traffic flow, where the instruction to perform the traffic classification is output in accordance with both the change of the ingress rate satisfying the at least one ingress rate threshold and the confidence score satisfying a confidence score threshold.

Clause 30: The apparatus of any of clauses 23-29, where the at least one ingress rate threshold is associated with an ingress rate range defined by an ingress rate lower bound and an ingress rate upper bound, and the at least one ingress rate threshold is satisfied in accordance with the change in the ingress rate resulting in the ingress rate being within the ingress rate range for at least the threshold duration.

Clause 31: The apparatus of any of clauses 23-30, where the at least one ingress rate threshold is associated with a threshold increase of the ingress rate, a threshold decrease of the ingress rate, a threshold duration since a previous increase or decrease of the ingress rate, or any combination thereof.

Clause 32: The apparatus of any of clauses 23-31, where the at least one ingress rate threshold is associated with an ingress rate increase over time, an ingress rate decrease over time, a total time between an ingress rate increase and an ingress rate decrease, or any combination thereof.

Clause 33: The apparatus of any of clauses 23-32, where, to obtain the information indicative of the ingress rate, the processing system is configured to cause the apparatus to: obtain information indicative of a set of multiple ingress rates associated with a set of multiple traffic flows of the application, each ingress rate of the set of multiple ingress rates being associated with a respective traffic flow of the set of multiple traffic flows, where the set of multiple ingress rates includes the ingress rate and the set of multiple traffic flows includes the traffic flow.

Clause 34: The apparatus of any of clauses 23-33, where the set of multiple traffic classes includes a video traffic classification, a voice traffic classification, a game traffic classification, a video stream classification, a live cast classification, one or more classification types associated with an AI/ML model, a background traffic classification, an unknown traffic classification, or any combination thereof.

Clause 35: The apparatus of clause 34, where the first traffic class is associated with the unknown traffic classification. In some aspects, the traffic class with which the at least one ingress rate threshold is associated (which may be a second traffic class other than the first traffic class) is associated with the video traffic classification, the voice traffic classification, the game traffic classification, or the background traffic classification.

Clause 36: The apparatus of any of clauses 23-35, where the set of multiple traffic classes is associated with a set of multiple traffic class groups, each traffic class group of the set of multiple traffic class groups includes a respective set of traffic classes of the set of multiple traffic classes, each traffic class group of the set of multiple traffic class groups is associated with a respective ingress rate behavior, and a traffic classification instruction is output in accordance with a satisfaction of an ingress rate behavior.

Clause 37: The apparatus of clause 36, where the first traffic class is within a first traffic class group of the set of multiple traffic class groups that is associated with a first ingress rate behavior, and the instruction to perform the traffic classification is output in accordance with the change of the ingress rate further satisfying a second ingress rate behavior associated with a second traffic class group of the set of multiple traffic class groups.

Clause 38: The apparatus of any of clauses 23-37, where the traffic classification is associated with an AI/ML model and the instruction to perform the traffic classification is output to the AI/ML model.

Clause 39: An apparatus, including: a processing system that includes processor circuitry and memory circuitry that stores code, the processing system configured to cause the apparatus to: obtain an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues; and output an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Clause 40: The apparatus of clause 39, where the processing system is further configured to cause the apparatus to: obtain an indication that the traffic classification of the set of multiple traffic flows associated with the first traffic flow queue fails to result in a satisfaction of the SLA associated with the traffic flow; and output a second instruction to perform a second traffic classification of a second set of multiple traffic flows associated with a second traffic flow queue, of the set of multiple traffic flow queues, in accordance with the indication that the traffic classification of the set of multiple traffic flows associated with the first traffic flow queue failed to result in the satisfaction of the SLA, where the second traffic flow queue is associated with a prioritized traffic flow queue associated with a defined SLA.

Clause 41: The apparatus of any of clauses 39-40, where outputting the instruction is in accordance with the failure to satisfy the SLA being independent from network noise, an SNR, or both.

Clause 42: The apparatus of any of clauses 39-41, where the failure to satisfy the SLA is associated with a failure to satisfy a throughput threshold associated with the SLA, a latency threshold associated with the SLA, or both.

Clause 43: The apparatus of any of clauses 39-42, where the SLA is further associated with the first traffic flow queue.

Clause 44: The apparatus of any of clauses 39-43, where the traffic classification is associated with an AI/ML model and the instruction to perform the traffic classification is output to the AI/ML model.

Clause 45: An apparatus for classifying traffic of wireless communications, including: means for obtaining information indicative of an ingress rate associated with a traffic flow of an application, where the traffic flow is associated with a first traffic class of a set of multiple traffic classes corresponding to the application; and means for outputting an instruction to perform a traffic classification of at least the traffic flow in accordance with a change of the ingress rate satisfying at least one ingress rate threshold associated with a traffic class of the set of multiple traffic classes and in accordance with the change of the ingress rate satisfying the at least one ingress rate threshold for at least a threshold duration, the threshold duration associated with at least one of the change of the ingress rate or the first traffic class.

Clause 46: The apparatus of clause 45, where the means for obtaining the information indicative of the ingress rate include: means for obtaining an indication that the change of the ingress rate of the traffic flow satisfies the at least one ingress rate threshold, where outputting the instruction to perform the traffic classification is in accordance with the indication.

Clause 47: The apparatus of any of clauses 45-46, where the threshold duration is associated with a direction of the change of the ingress rate, a magnitude of the change of the ingress rate, or both.

Clause 48: The apparatus of clause 47, where the threshold duration is a first quantity of time domain units in accordance with the direction of the change of the ingress rate being an ingress rate decrease; and the threshold duration is a second quantity of time domain units in accordance with the direction of the change of the ingress rate being an ingress rate increase, the second quantity of time domain units being less than the first quantity of time domain units.

Clause 49: The apparatus of any of clauses 47-48, where the threshold duration is zero seconds in accordance with the direction of the change of the ingress rate being an ingress rate increase and the magnitude of the change of the ingress rate satisfying a threshold magnitude.

Clause 50: The apparatus of any of clauses 45-49, where the threshold duration is associated with the first traffic class.

Clause 51: The apparatus of any of clauses 45-50, further including: means for obtaining a confidence score associated with the first traffic class associated with the traffic flow, where the instruction to perform the traffic classification is output in accordance with both the change of the ingress rate satisfying the at least one ingress rate threshold and the confidence score satisfying a confidence score threshold.

Clause 52: The apparatus of any of clauses 45-51, where the at least one ingress rate threshold is associated with an ingress rate range defined by an ingress rate lower bound and an ingress rate upper bound, and the at least one ingress rate threshold is satisfied in accordance with the change in the ingress rate resulting in the ingress rate being within the ingress rate range for at least the threshold duration.

Clause 53: The apparatus of any of clauses 45-52, where the at least one ingress rate threshold is associated with a threshold increase of the ingress rate, a threshold decrease of the ingress rate, a threshold duration since a previous increase or decrease of the ingress rate, or any combination thereof.

Clause 54: The apparatus of any of clauses 45-53, where the at least one ingress rate threshold is associated with an ingress rate increase over time, an ingress rate decrease over time, a total time between an ingress rate increase and an ingress rate decrease, or any combination thereof.

Clause 55: The apparatus of any of clauses 45-54, where the means for obtaining the information indicative of the ingress rate include: means for obtaining information indicative of a set of multiple ingress rates associated with a set of multiple traffic flows of the application, each ingress rate of the set of multiple ingress rates being associated with a respective traffic flow of the set of multiple traffic flows, where the set of multiple ingress rates includes the ingress rate and the set of multiple traffic flows includes the traffic flow.

Clause 56: The apparatus of any of clauses 45-55, where the set of multiple traffic classes includes a video traffic classification, a voice traffic classification, a game traffic classification, a video stream classification, a live cast classification, one or more classification types associated with an AI/ML model, a background traffic classification, an unknown traffic classification, or any combination thereof.

Clause 57: The apparatus of clause 56, where the first traffic class is associated with the unknown traffic classification. In some aspects, the traffic class with which the at least one ingress rate threshold is associated (which may be a second traffic class other than the first traffic class) is associated with the video traffic classification, the voice traffic classification, the game traffic classification, or the background traffic classification.

Clause 58: The apparatus of any of clauses 45-57, where the set of multiple traffic classes is associated with a set of multiple traffic class groups, each traffic class group of the set of multiple traffic class groups includes a respective set of traffic classes of the set of multiple traffic classes, each traffic class group of the set of multiple traffic class groups is associated with a respective ingress rate behavior, and a traffic classification instruction is output in accordance with a satisfaction of an ingress rate behavior.

Clause 59: The apparatus of clause 58, where the first traffic class is within a first traffic class group of the set of multiple traffic class groups that is associated with a first ingress rate behavior, and the instruction to perform the traffic classification is output in accordance with the change of the ingress rate further satisfying a second ingress rate behavior associated with a second traffic class group of the set of multiple traffic class groups.

Clause 60: The apparatus of any of clauses 45-59, where the traffic classification is associated with an AI/ML model and the instruction to perform the traffic classification is output to the AI/ML model.

Clause 61: An apparatus for classifying traffic of wireless communications, including: means for obtaining an indication of a failure to satisfy an SLA associated with a traffic flow of an application, the traffic flow associated with a first traffic class of a set of multiple traffic classes corresponding to the application, where the first traffic class is associated with a first traffic flow queue of a set of multiple traffic flow queues, and where the failure to satisfy the SLA is associated with a traffic flow congestion of at least one traffic flow queue of the set of multiple traffic flow queues; and means for outputting an instruction to perform a traffic classification of a set of multiple traffic flows associated with the first traffic flow queue in accordance with the failure to satisfy the SLA associated with the traffic flow and in accordance with the failure to satisfy the SLA being associated with the traffic flow congestion of the at least one traffic flow queue.

Clause 62: The apparatus of clause 61, further including: means for obtaining an indication that the traffic classification of the set of multiple traffic flows associated with the first traffic flow queue fails to result in a satisfaction of the SLA associated with the traffic flow; and means for outputting a second instruction to perform a second traffic classification of a second set of multiple traffic flows associated with a second traffic flow queue, of the set of multiple traffic flow queues, in accordance with the indication that the traffic classification of the set of multiple traffic flows associated with the first traffic flow queue failed to result in the satisfaction of the SLA, where the second traffic flow queue is associated with a prioritized traffic flow queue associated with a defined SLA.

Clause 63: The apparatus of any of clauses 61-62, where outputting the instruction is in accordance with the failure to satisfy the SLA being independent from network noise, an SNR, or both.

Clause 64: The apparatus of any of clauses 61-63, where the failure to satisfy the SLA is associated with a failure to satisfy a throughput threshold associated with the SLA, a latency threshold associated with the SLA, or both.

Clause 65: The apparatus of any of clauses 61-64, where the SLA is further associated with the first traffic flow queue.

Clause 66: The apparatus of any of clauses 61-65, where the traffic classification is associated with an AI/ML model and the instruction to perform the traffic classification is output to the AI/ML model.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination may be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus, comprising:
a processing system that includes processor circuitry and memory circuitry that stores code, the processing system configured to cause the apparatus to:
obtain information indicative of an ingress rate associated with a traffic flow of an application, wherein the traffic flow is associated with a first traffic class of a plurality of traffic classes corresponding to the application; and
output an instruction to perform a traffic classification of at least the traffic flow in accordance with:
a change of the ingress rate that satisfies at least one ingress rate threshold associated with a traffic class of the plurality of traffic classes, and
the change of the ingress rate that satisfies the at least one ingress rate threshold for at least a threshold duration, the threshold duration associated with at least one of the change of the ingress rate or the first traffic class.

2. The apparatus of claim 1, wherein, to obtain the information indicative of the ingress rate, the processing system is further configured to cause the apparatus to:
obtain an indication that the change of the ingress rate of the traffic flow satisfies the at least one ingress rate threshold, wherein the instruction to perform the traffic classification is output in accordance with the indication.

3-6. (canceled)

7. The apparatus of claim 1, wherein the processing system is further configured to cause the apparatus to:
obtain a confidence score associated with the first traffic class associated with the traffic flow, wherein the instruction to perform the traffic classification is output in accordance with both the change of the ingress rate satisfying the at least one ingress rate threshold and the confidence score satisfying a confidence score threshold.

8. The apparatus of claim 1, wherein:
the at least one ingress rate threshold is associated with an ingress rate range defined by an ingress rate lower bound and an ingress rate upper bound, and
the at least one ingress rate threshold is satisfied in accordance with the change in the ingress rate resulting in the ingress rate being within the ingress rate range for at least the threshold duration.

9. The apparatus of claim 1, wherein the at least one ingress rate threshold is associated with a threshold increase of the ingress rate, a threshold decrease of the ingress rate, a threshold duration since a previous increase or decrease of the ingress rate, or any combination thereof.

10. The apparatus of claim 1, wherein the at least one ingress rate threshold is associated with an ingress rate increase over time, an ingress rate decrease over time, a total time between an ingress rate increase and an ingress rate decrease, or any combination thereof.

11. The apparatus of claim 1, wherein, to obtain the information indicative of the ingress rate, the processing system is configured to cause the apparatus to:
obtain information indicative of a plurality of ingress rates associated with a plurality of traffic flows of the application, each ingress rate of the plurality of ingress rates being associated with a respective traffic flow of the plurality of traffic flows, wherein the plurality of ingress rates comprises the ingress rate and the plurality of traffic flows comprises the traffic flow.

12. The apparatus of claim 1, wherein the plurality of traffic classes comprises a video traffic classification, a voice traffic classification, a game traffic classification, a video stream classification, a live cast classification, one or more classification types associated with an artificial intelligence or machine learning (AT/ML) model, a background traffic classification, an unknown traffic classification, or any combination thereof.

13. (canceled)

14. The apparatus of claim 1, wherein:
the plurality of traffic classes is associated with a plurality of traffic class groups, each traffic class group of the plurality of traffic class groups comprises a respective set of traffic classes of the plurality of traffic classes, and each traffic class group of the plurality of traffic class groups is associated with a respective ingress rate behavior, and a traffic classification instruction is output in accordance with a satisfaction of an ingress rate behavior.

15. The apparatus of claim 14, wherein:
the first traffic class is within a first traffic class group of the plurality of traffic class groups that is associated with a first ingress rate behavior, and
the instruction to perform the traffic classification is output in accordance with the change of the ingress rate further satisfying a second ingress rate behavior associated with a second traffic class group of the plurality of traffic class groups.

16. (canceled)

17. An apparatus, comprising:
a processing system that includes processor circuitry and memory circuitry that stores code, the processing system configured to cause the apparatus to:
obtain an indication of a failure to satisfy a service level agreement associated with a traffic flow of an application, the traffic flow associated with a first traffic class of a plurality of traffic classes corresponding to the application, wherein the first traffic class is associated with a first traffic flow queue of a plurality of traffic flow queues, and wherein the failure to satisfy the service level agreement is associated with a traffic flow congestion of at least one traffic flow queue of the plurality of traffic flow queues; and
output an instruction to perform a traffic classification of a plurality of traffic flows associated with the first traffic flow queue in accordance with:
the failure to satisfy the service level agreement associated with the traffic flow, and
the failure to satisfy the service level agreement being associated with the traffic flow congestion of the at least one traffic flow queue.

18. The apparatus of claim 17, wherein the processing system is further configured to cause the apparatus to:
obtain an indication that the traffic classification of the plurality of traffic flows associated with the first traffic flow queue fails to result in a satisfaction of the service level agreement associated with the traffic flow; and
output a second instruction to perform a second traffic classification of a second plurality of traffic flows associated with a second traffic flow queue, of the plurality of traffic flow queues, in accordance with the indication that the traffic classification of the plurality of traffic flows associated with the first traffic flow queue failed to result in the satisfaction of the service level agreement, wherein the second traffic flow queue is associated with a prioritized traffic flow queue associated with a defined service level agreement.

19. The apparatus of claim 17, wherein the instruction is output in accordance with the failure to satisfy the service level agreement being independent from network noise, a signal-to-noise ratio, or both.

20. The apparatus of claim 17, wherein the failure to satisfy the service level agreement is associated with a failure to satisfy a throughput threshold associated with the service level agreement, a latency threshold associated with the service level agreement, or both.

21. (canceled)

22. (canceled)

23. A method for traffic classification, comprising:
obtaining information indicative of an ingress rate associated with a traffic flow of an application, wherein the traffic flow is associated with a first traffic class of a plurality of traffic classes corresponding to the application; and
outputting an instruction to perform a traffic classification of at least the traffic flow in accordance with:
a change of the ingress rate satisfying at least one ingress rate threshold associated with a traffic class of the plurality of traffic classes, and
the change of the ingress rate satisfying the at least one ingress rate threshold for at least a threshold duration, the threshold duration associated with at least one of the change of the ingress rate or the first traffic class.

24. (canceled)

25. The method of claim 23, wherein the threshold duration is associated with a direction of the change of the ingress rate, a magnitude of the change of the ingress rate, or both.

26. The method of claim 25, wherein:
the threshold duration is a first quantity of time domain units in accordance with the direction of the change of the ingress rate being an ingress rate decrease; and
the threshold duration is a second quantity of time domain units in accordance with the direction of the change of the ingress rate being an ingress rate increase, the second quantity of time domain units being less than the first quantity of time domain units.

27. The method of claim 25, wherein the threshold duration is zero seconds in accordance with the direction of the change of the ingress rate being an ingress rate increase and the magnitude of the change of the ingress rate satisfying a threshold magnitude.

28. The method of claim 23, wherein the threshold duration is associated with the first traffic class.

29. The method of claim 23, further comprising:
obtaining a confidence score associated with the first traffic class associated with the traffic flow, wherein the instruction to perform the traffic classification is output in accordance with both the change of the ingress rate satisfying the at least one ingress rate threshold and the confidence score satisfying a confidence score threshold.

30-44. (canceled)
